(19) United States
(12) Patent Application Publication
(10) Pub. No.: US 2025/0110377 A1
(43) Pub. Date: Apr. 3, 2025

(54) Smart Glass System Pane Mapping

(71) Applicant: SAGE Electrochromics, Inc., Faribault, MN (US)

(72) Inventors: Bryan D. Greer, Northfield, MN (US); David Best, Elysian, MN (US); David Ryan Buszmann, Elko New Market, MN (US); Nicholas Iverson, Farmington, MN (US)

(73) Assignee: SAGE Electrochromics, Inc., Faribault, MN (US)

(21) Appl. No.: 18/824,798

(22) Filed: Sep. 4, 2024

Related U.S. Application Data
(60) Provisional application No. 63/586,958, filed on Sep. 29, 2023.

(51) Int. Cl. G02F 1/157; E06B 9/24; G02F 1/163

(52) U.S. Cl. CPC G02F 1/157; E06B 9/24; G02F 1/163; E06B 2009/2464; G02F 2203/01

(57) ABSTRACT

A system with one or more smart glass units is provided. The system includes a smart glass unit and a controller. The controller is configured to send, using one or more wires, a tint signal to the smart glass unit to control a tint level of the smart glass unit. The controller is also configured to send, using the same one or more wires, a detection signal, independent of the tint signal, to the smart glass unit for determining a location of the smart glass unit via at least one of an electric field coupling or a magnetic field coupling.

### PRIORITY APPLICATION

This application claims benefit of priority to U.S. Provisional Application Ser. No. 63/586,958, entitled “Smart Glass Systems Pane Mapping,” filed Sep. 29, 2023, and which is hereby incorporated herein by reference in its entirety.

### FIELD OF THE DISCLOSURE

The present disclosure is directed to one or more smart glass units, and more specifically to various approaches for mapping smart glass units, smart glass unit locations, and controllers together for smart glass unit system operations.

### BACKGROUND

Smart glass may be used to decrease heat transfer through a window and/or reduce the transmission of visible light to provide tinting or shading. Smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Complications can arise during installation of the smart glass units with respect to mapping the smart glass unit to respective locations for tint level control.

### SUMMARY

In some aspects, a system is provided. The system includes a smart glass unit. The system also includes a controller. The controller is configured to send, using one or more wires, a tint signal to the smart glass unit to control a tint level of the smart glass unit. The controller is also configured to send, using the same one or more wires, a detection signal, independent of the tint signal, to the smart glass unit for determining a location of the smart glass unit via at least one of an electric field coupling or a magnetic field coupling. In some aspects, the controller is configured to send the detection signal to the smart glass unit for determining the location of the smart glass unit without controlling the tint level of the smart glass unit. In some aspects, the smart glass unit includes a first smart glass unit, the system further includes a second smart glass unit, and the controller is further configured to send the detection signal to the second smart glass unit for determining a location of the second smart glass unit. In some aspects, the smart glass unit includes a first smart glass unit, the detection signal includes a first detection signal, the system further includes a second smart glass unit, and the controller is further configured to send a second detection signal, different from the first detection signal, to the second smart glass unit, independent of the first detection signal, for identifying the location of the second smart glass unit via at least one of the electric field coupling or the magnetic field coupling. In some aspects, the smart glass unit includes a first smart glass unit, the system further includes a second smart glass unit, and the controller is further configured to after sending the detection signal to the first smart glass unit for determining the location of the first smart glass unit, send the detection signal to the second smart glass unit for determining the location of the second smart glass unit. In some aspects, the detection signal is configured to generate one or more tones including at least one of a specific pitch assigned to the smart glass unit, a series of pitches assigned to the smart glass unit, or a sequence of pulses assigned to the smart glass unit. In some aspects, the detection signal includes a frequency assigned to the smart glass unit. In some aspects, the system further includes a detector. The detector is configured to capacitively detect, via the electric field coupling, or inductively detect, via the magnetic field coupling, the detection signal at the smart glass unit, and produce at least one of a light indication, a vibration, or a sound based on the detection signal for determining the location of the smart glass unit. In some aspects, the detector is further configured to transmit the location of the smart glass unit to the controller for associating the detection signal with the location of the smart glass unit. In some aspects, the location of the smart glass unit is based on a location of the detector, determined by the detector when the detector detects the detection signal at the smart glass unit. In some aspects, the controller shares a physical location with the smart glass unit. In some aspects, the controller is positioned at a different location than the smart glass unit.

In some aspects, a system is provided. The system includes a controller. The controller is configured to transmit, through one or more wires associated with a smart glass unit, a tint signal for the smart glass unit to control a tint level of the smart glass unit. The controller is also configured to transmit a detection signal, through the same one or more wires associated with the smart glass unit, for determining a location of the smart glass unit, the detection signal does not control the tint level of the smart glass unit. In some aspects, the controller is configured to transmit the detection signal through one or more other wires for determining a location of another smart glass unit. In some aspects, the detection signal includes a first detection signal, and the controller is further configured to transmit a second detection signal, different from the first detection signal, through one or more other wires associated with another smart glass unit for determining a location of the other smart glass unit, where the second detection signal is different from the first detection signal. In some aspects, the controller is configured to after transmitting the detection signal through the one or more wires associated with the smart glass unit for determining the location of the smart glass unit, transmit the detection signal through one or more other wires associated with another smart glass unit for determining a location of the other smart glass unit.

In some aspects, a system is provided. The system includes a supervisory controller. The system also includes a data storage for storing mappings of detection signals with respective locations of smart glass units. The system further includes a plurality of controllers in electronic communication with the supervisory controller, where the plurality of controllers comprises at least a first controller and a second controller. In addition, the system includes a first smart glass unit electrically wired to the first controller. The system includes a second smart glass unit electrically wired to the second controller. The supervisory controller is configured to send a first command to the first controller and the second controller to send a tint signal to the first smart glass unit and the second smart glass unit, respectively, to control a tint level of the first smart glass unit and the second smart glass unit, respectively. The supervisory controller is also configured to send a second command to the first controller and the second controller to send respective detection signals, independent of the tint signal, to the first smart glass unit and the second smart glass unit for determining respective locations of the first smart glass unit and the second smart glass unit. The supervisory controller is further configured to receive a first signal mapping the detection signal sent to the first smart glass unit with the location of the first smart glass unit and store the mapping of the detection signal sent to the first smart glass unit and the location of the first smart glass unit in the data storage. In addition, the supervisory controller is configured to receive a second signal mapping the detection signal sent to the second smart glass unit with the location of the second smart glass unit and store the mapping of the detection signal sent to the second smart glass unit and the location of the second smart glass unit in the data storage. In some aspects, the supervisory controller is configured to send the second command to the first controller so that the first controller sends the detection signal to the first smart glass unit for identifying the first smart glass unit without sending the tint signal to control the tint level of the first smart glass unit, and where the supervisory controller is configured to send the second command to the second controller so that the second controller sends the detection signal to the second smart glass unit for identifying the first smart glass unit without sending the tint signal to control the tint level of the second smart glass unit. In some aspects, the controller shares a location with the first smart glass unit and the second controller shares a location with the second smart glass unit. In some aspects, the first controller is positioned at a different location than the first smart glass unit, and wherein the second controller is positioned at a different location than the second smart glass unit.

In some aspects, a signal detector system for a smart glass unit system is provided. The signal detector system includes a detector configured to detect a detection signal via at least one of an electric field coupling or a magnetic field coupling. The signal detector system also includes a controller configured to determine a location of the smart glass unit at the time the detection signal is detected via at least one of the electric field coupling or the magnetic field coupling. The signal detector system further includes a transmitter configured to transmit a signal to a system controller that includes the location of the smart glass unit at the time the detection signal is detected via at least one of the electric field coupling or the magnetic field coupling. In some aspects, the controller is further configured to determine a location of the detector at the time the detector detects the detection signal via at least one of the electric field coupling or the magnetic field coupling, and wherein the location of the smart glass unit at the time the detection signal is detected via at least one of the electric field coupling or the magnetic field coupling is based on the location of the signal detector. In some aspects, the detection signal is configured to generate one or more tones including at least one of a specific pitch assigned to the smart glass unit, a series of pitches assigned to the smart glass unit, or a sequence of pulses assigned to the smart glass unit. In some aspects, the detection signal includes a frequency assigned to the smart glass unit.

### BRIEF DESCRIPTION OF THE DRAWINGS

FIG. 1 illustrates a perspective view of an example EC system according to some aspects of this disclosure.

FIG. 2 illustrates a block diagram of an example system according to some aspects of this disclosure.

FIG. 3 illustrates a perspective view of an example detector system according to some aspects of this disclosure.

FIG. 4 illustrates a block diagram of an example system according to some aspects of this disclosure.

FIG. 5 illustrates a block diagram of an example system according to some aspects of this disclosure.

FIG. 6 illustrates a block diagram of an example method according to some aspects of this disclosure.

FIG. 7 illustrates a block diagram of an example method according to some aspects of this disclosure.

FIG. 8 illustrates a block diagram of an example method according to some aspects of this disclosure.

FIG. 9 illustrates a block diagram of an example method according to some aspects of this disclosure.

FIG. 10 illustrates an example computer system that may be used in some embodiments.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may be as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Many smart glass systems utilize complicated wire configurations to achieve sufficient functionality and operability.

The installation process for installing a plurality of smart glass units with a building can be complicated and labor intensive. For example, smart glass unit control systems may be wired to a large number of smart glass units (e.g., hundreds, thousands) respectively located in different areas (e.g., walls, rooms, ceilings) of a building. After installing wiring for electronic communication and/or power distribution between the control system and respective smart glass units, it may not always be known which physical smart glass unit location corresponds to a particular controller and specific output on the controller needed for proper control. In some aspects, to address this problem, respective smart glass units may be individually (e.g., one at a time) tinted (e.g., initiated to have a tint change) to verify that wiring wired from the control system is wired to a smart glass unit at a planned location. However, individually tinting respective smart glass unit may be slow (e.g., tinting changes may take several minutes to occur) and time consuming. In some cases, smart glass unit verification by individually tinting respective smart glass units may be accelerated by commanding different smart glass units to have different tint levels (e.g., different levels of darkness through different smart glass units) and by monitoring those smart glass units over time. However, this process is complex and may not work well if many smart glass units cannot be seen by one camera at the same time. In some aspects, respective smart glass units may include indicator lights and/or sensors for location verification. However, such smart glass units require additional hardware (e.g., the indicator lights, sensors) increasing the cost of the smart glass units and installation complexity.

As described herein, a smart glass unit system and/or a smart glass unit is provided that enables detection of particular smart glass units or a plurality of particular smart glass units (e.g., one at a time, in particular sequence, simultaneously) to determine which physical smart glass unit location corresponds to a particular controller and the specific output on the controller needed for proper control without installing additional hardware with the controller and/or the smart glass units and without consuming the additional time needed to send tint control signals to respective smart glass units to change or maintain a tint level of those smart glass unit for verification. The smart glass unit system and/or the smart glass unit may include a controller. The controller is configured to transmit, via one or more wires, a detection signal for detecting a particular smart glass unit or a plurality of particular smart glass units (e.g., one at a time, in particular sequence, simultaneously). The detection signal may be detected using an external detection device that is separate from the smart glass unit and the controller. The external detection device capacitively detects, via electric field coupling, and/or inductively detects, via magnetic field coupling, the detection signal over the wire(s) associated with the particular smart glass unit and/or adjacent (e.g., against) a pane of the particular smart glass unit(s). For example, the controller may be configured to generate and send a detection signal that does not control a tint or a tint level of a particular smart glass unit for detection of the smart glass unit by the external detection device. In other words, the controller may be configured to generate and send a detection signal that is independent of (e.g., separate from) a tint control signal. The controller is configured to generate and send a detection signal without changing any hardware of the controller and the smart glass unit. For instance, the hardware that is used to form or manufacture a controller that does not produce (e.g., generate) and transmit a detection signal may be the same hardware that is used to form or manufacture the controller that does produce (e.g., generate) and transmit a detection signal. As another example, the hardware that is used to form or manufacture a smart glass unit for receiving from a controller non-detection signals via wire(s) in electronic communication with the controller may be the same hardware that is used to form or manufacture a smart glass unit for receiving detection signals from a controller via wire(s) in electronic communication with the controller for detection of the smart glass unit. In other words, no additional hardware (e.g., lights, speakers, and/or other indicators) need to be included with the smart glass unit to receive a detection signal and detect the smart glass unit as described herein.

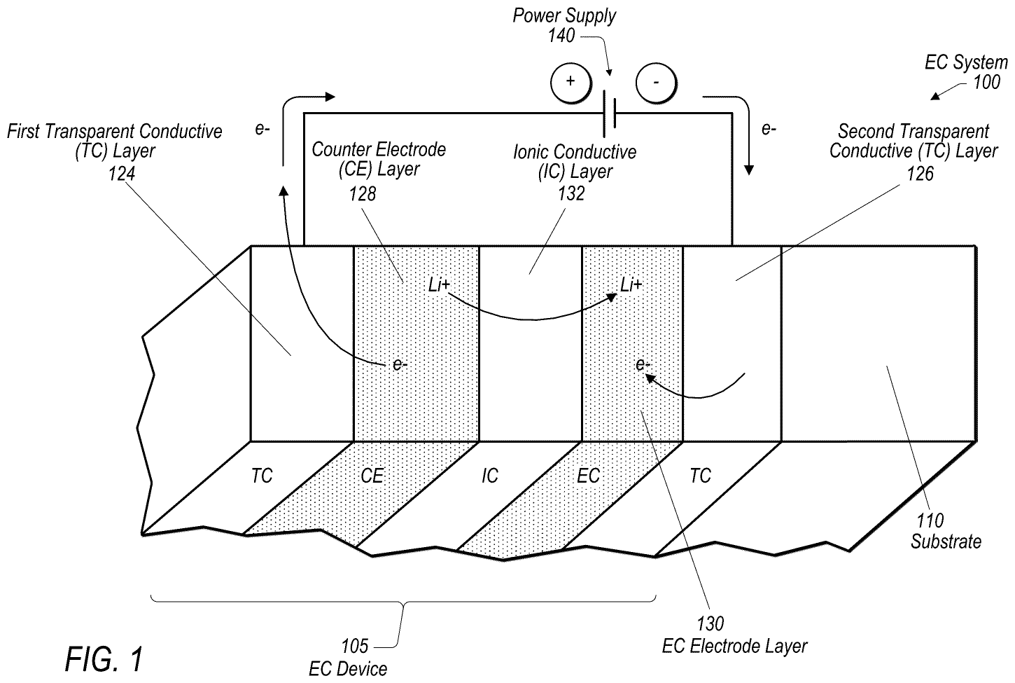

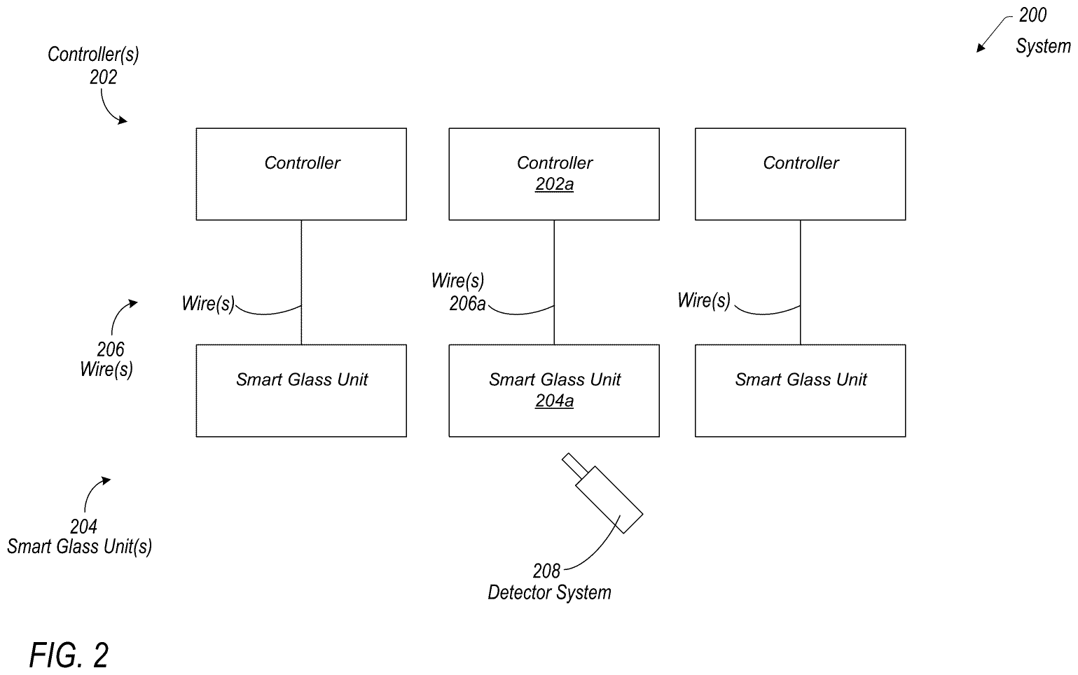

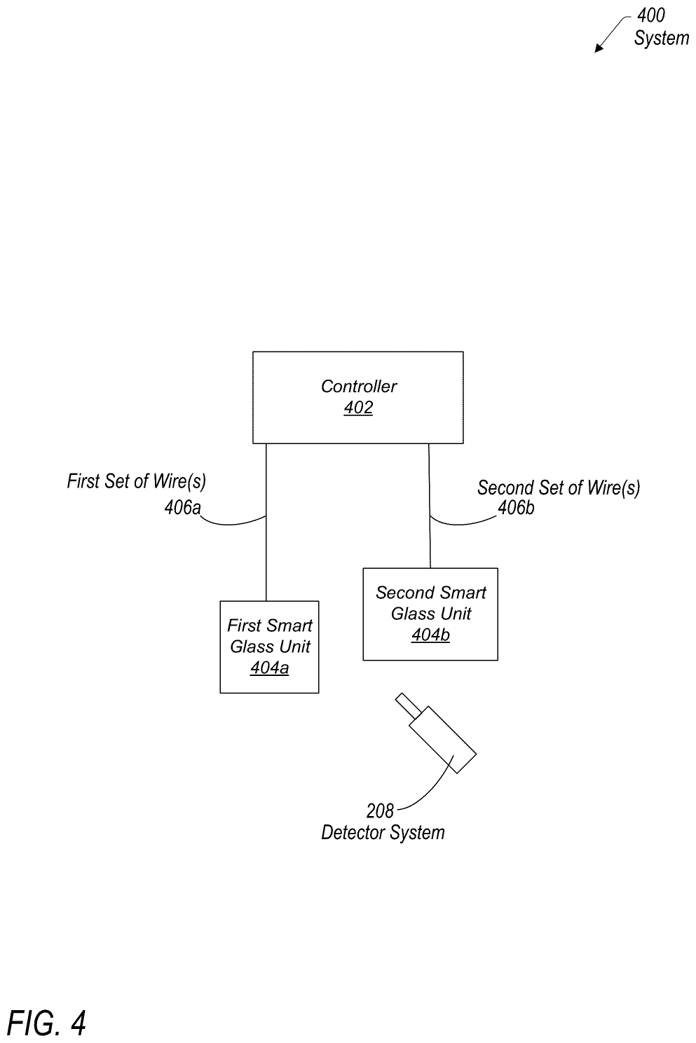

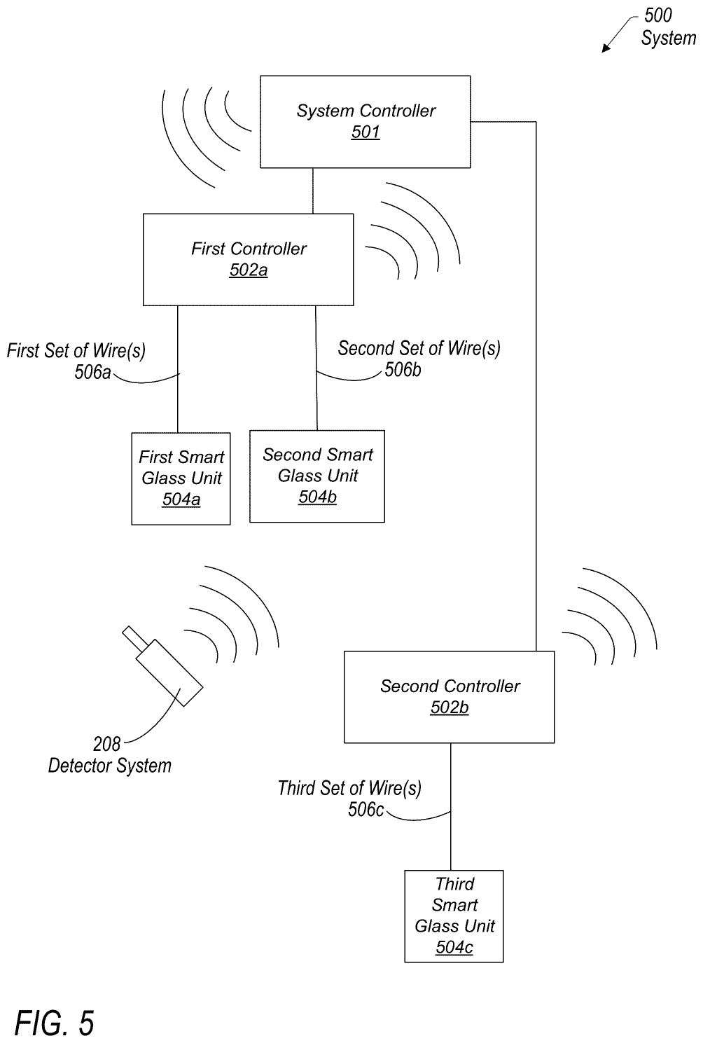

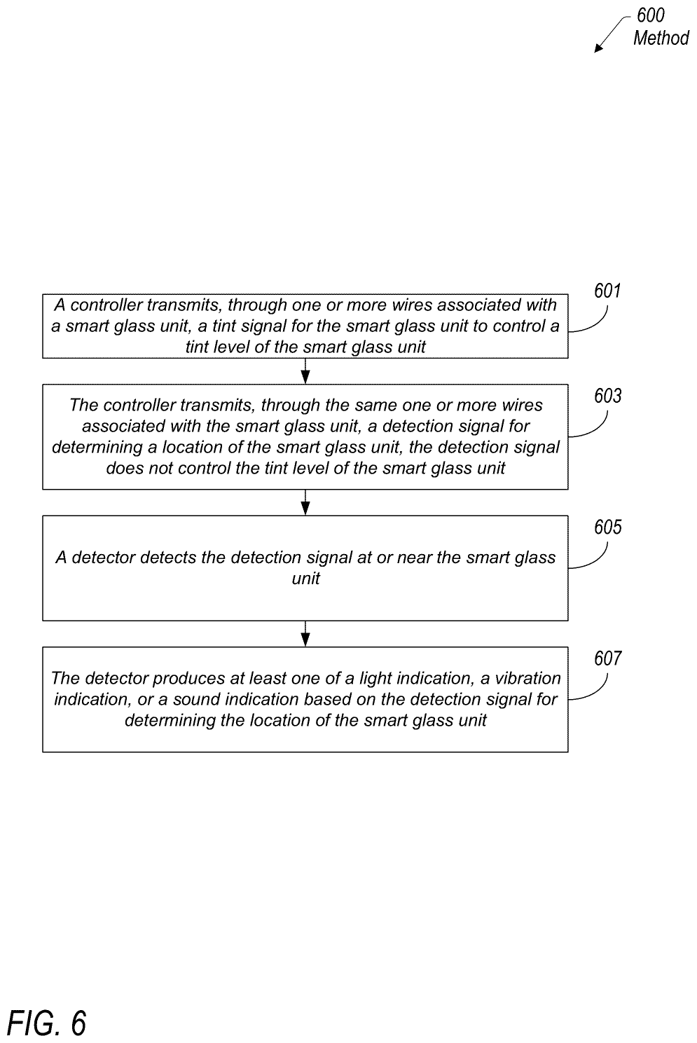

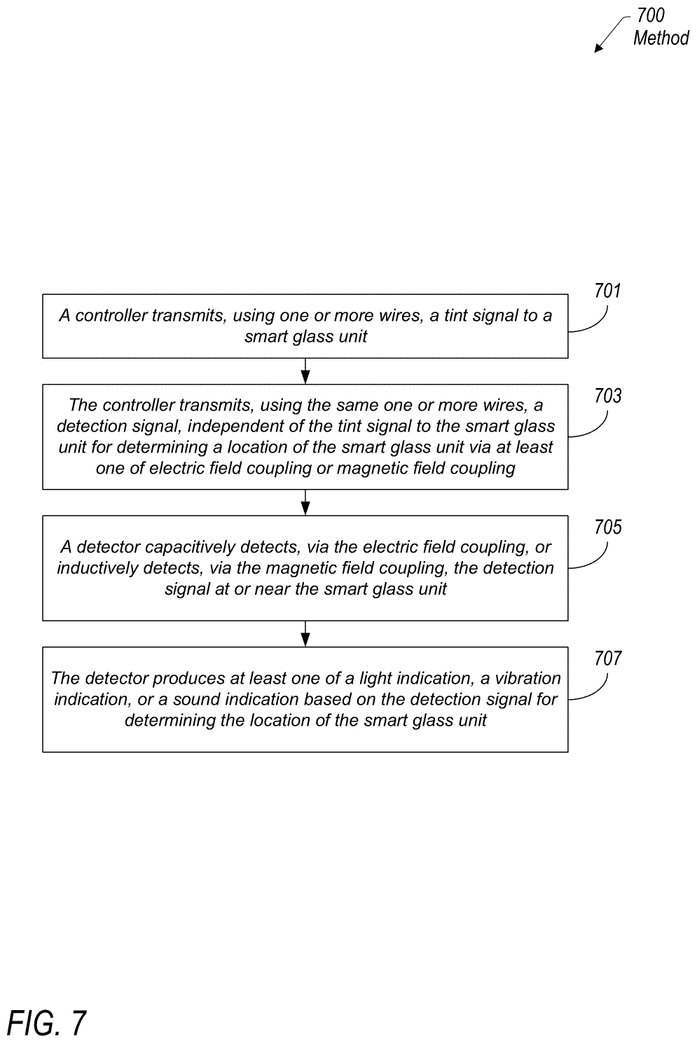

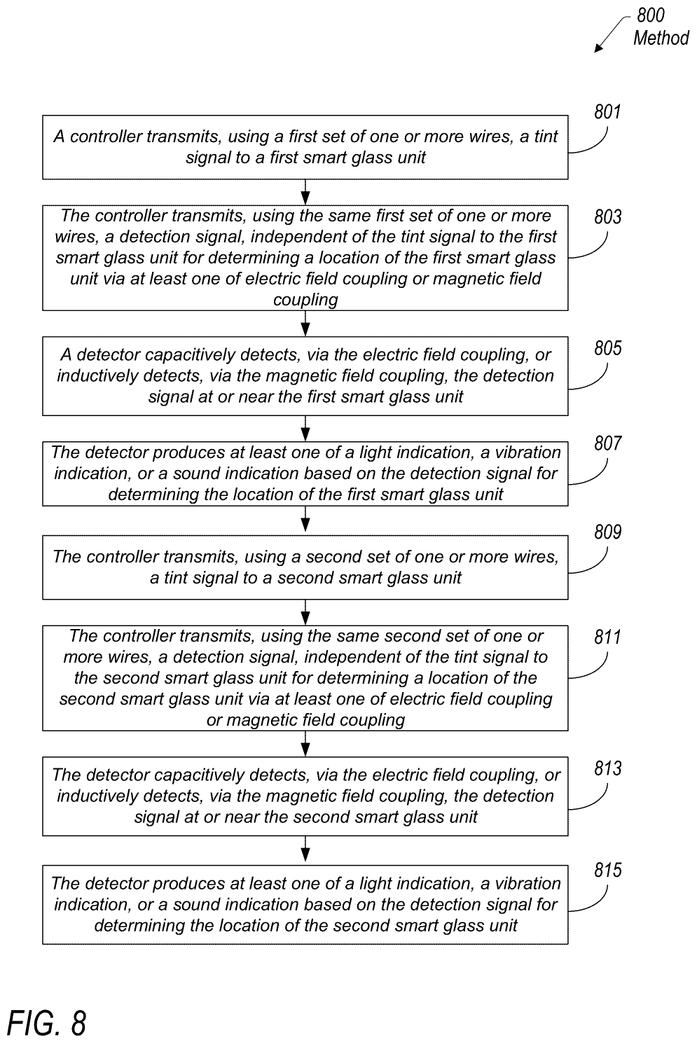

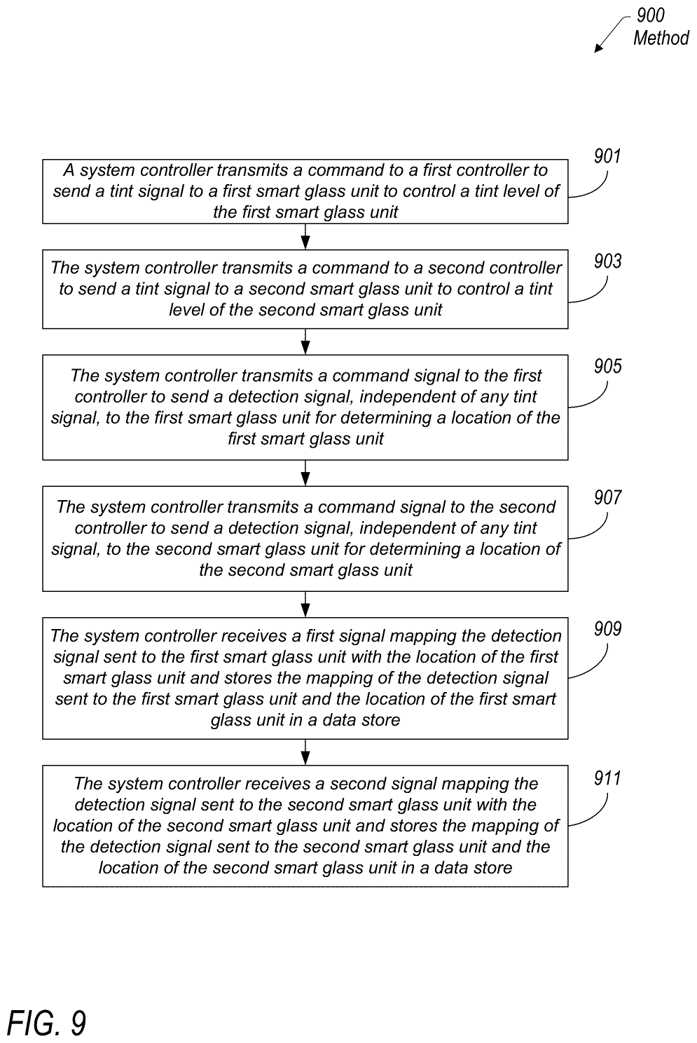

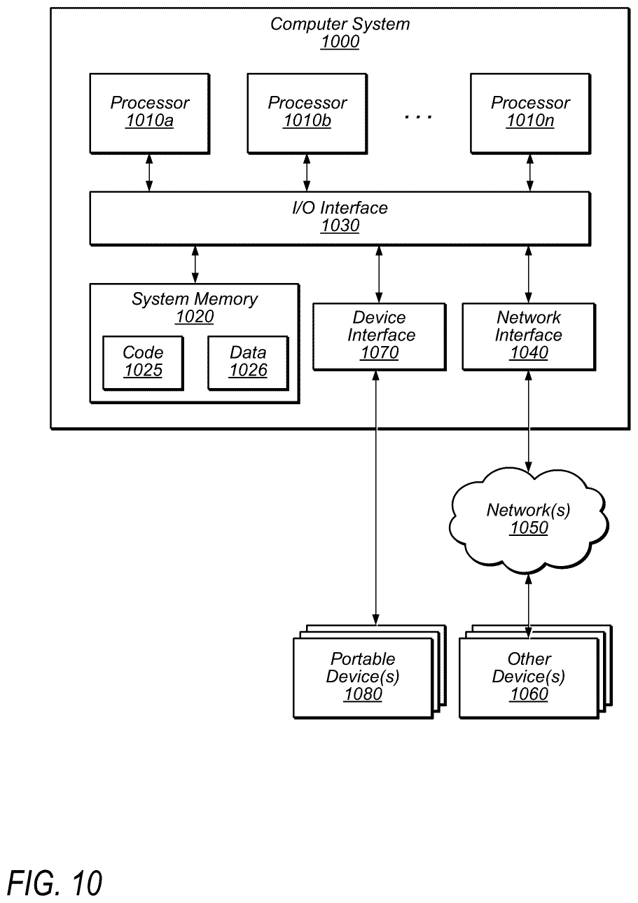

FIG. 1 illustrates a perspective view of an example EC system 100 according to some aspects of this disclosure. The EC system 100 may include one or more same or similar features as the features described with respect to or illustrated in FIGS. 2, 4, 5, and 10. For example, the EC system 100 may include one or more same or similar features as the features described with respect to the system 200 of FIG. 2, the system 400 of FIG. 4, the system 500 of FIG. 5, and/or the computer system 1000 of FIG. 10. The EC system of 100 of FIG. 1 may also implement any one or more steps described herein including one or more steps described with respect to the method 600 of FIG. 6, the method 700 of FIG. 7, the method 800 of FIG. 8, and/or the method 900 of FIG. 9. FIG. 1, as with the other included figures, is shown for illustrative purposes and does not limit either the possible embodiments of the present invention or the claims.

In this example, the EC system 100 may include an EC device 105 secured to a substrate 110. The EC device 105 may be a non-limiting example of a smart glass or smart glass unit as provided herein. The EC device 105 may include a thin film which may be deposited on to the substrate 110. The EC device 105 may include a first transparent conductive (TC) layer 124 and a second TC layer 126 in contact with the substrate 110. In some aspects, the first TC layer 124 and the second TC layer 126 may be, or may include, one or more transparent conductive oxide (TCO) layers. The substrate 110 may include one or more optically transparent materials, e.g., glass, plastic, and the like. The EC device 105 may also include one or more active layers. For example, the EC device 105 may include a counter electrode (CE) layer 128 in contact with the first TC layer 124 and an EC electrode layer 130 in contact with the second TC layer 126. An ionic conductor (IC) layer 132 may be positioned in-between (e.g., “sandwiched” between) the CE layer 128 and the EC electrode layer 130. The EC system 100 may include a power supply 140 which may provide regulated current or voltage to the EC device 105. Transparency of the EC device 105 may be controlled by regulating density of charges (or lithium ions) in the CE layer 128 and/or the EC electrode layer 130 of the EC device 105. For instance, when the EC system 100 applies a positive voltage from the power supply 140 to the first TC layer 124, lithium ions may be inserted into the EC electrode layer 130. In some aspects, when the EC system 100 applies a positive voltage from the power supply 140 to the first TC layer 124, lithium ions may be driven across the IC layer 132 and inserted into the EC electrode layer 130. Simultaneously, charge-compensating electrons may be extracted from the CE layer 128, may flow across the external circuit, and may flow into the EC electrode layer 130. Transfer of lithium ions and associated electrons from the CE layer 128 to the EC electrode layer 130 may cause the EC device 105 to become darker-e.g., the visible light transmission of the EC device 105 may decrease. Reversing the voltage polarity may cause the lithium ions and associated charges to return to their original layer, the CE layer 128, and as a result, the EC device 105 may return to a clear state-e.g., the visible light transmission of the EC device 105 may increase.

As described herein, a smart glass or device such as the EC device 105 of FIG. 1 may receive a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass.

FIG. 2 illustrates a block diagram of an example system 200 according to some aspects of this disclosure. The system 200 may include one or more same or similar features as the features described with respect to or illustrated in FIGS. 1, 4, 5, and 10. For example, the system 200 may include one or more same or similar features as the features described with respect to the EC system 100 of FIG. 1, the system 400 of FIG. 4, the system 500 of FIG. 5, and/or the computer system 1000 of FIG. 10. The system 200 of FIG. 2 may also implement any one or more steps described herein including one or more steps described with respect to the method 600 of FIG. 6, the method 700 of FIG. 7, the method 800 of FIG. 8, and/or the method 900 of FIG. 9. FIG. 2, as with the other included figures, is shown for illustrative purposes and does not limit either the possible embodiments of the present invention or the claims.

As shown in FIG. 2, the system 200 includes a plurality of controllers 202 including controller 202a, a plurality of smart glass units 204 including a controller 204a, and a plurality of wires 206 including wire(s) 206a. The system also includes a detector system 208. The smart glass unit 204a may include one or more features of the EC device 100 illustrated in FIG. 1. The smart glass unit 204a may be positioned within an interior or an exterior wall of an edifice or building for viewing therethrough. The controller 202a may be located near and/or within the smart glass unit 204a. For

example, the controller 202a may be integrated within a panel of the smart glass unit 204a. As another example, the controller 202a may be positioned adjacent or next to the smart glass unit 204a. As yet another example, the controller 202a may be positioned within a wall adjacent, next to, or near the smart glass unit 204a. Alternatively, the controller 202a may be located a distance away from the smart glass unit 204a. For example, the controller 202a may be located within a room of building that does not include the smart glass unit 204a. As another example, the controller 202a may be located above a ceiling or below a floor within a room that includes the smart glass unit 204a. As yet another example, the controller 202a may be located in another building that does not include the smart glass unit. The wire(s) 206a may electrically connect both the controller 202a and the smart glass unit 204a so that the wire(s) 206a may communicate signals from the controller 202a to the smart glass unit 204a. For example, the controller 202a may generate and transmit tint control signals, via the wire(s) 206a, the smart glass unit 204a to increase, decrease, or maintain a tint level of the smart glass unit 204a. As another example, the controller 202a may generate and transmit a smart glass unit detection signal, via the wire(s) 206a and independent of any other type of signal including a tint control signal, for detection of the smart glass unit 204a. The smart glass unit detection signal may be a signal that does not control a tint level of the smart glass unit 204a. It should be understood that the controller 202a may transmit both the tint control signal(s) and the smart glass unit detection signals over the same wire(s) 206a at the same time or at different times.

In some aspects, the smart glass unit detection signal may be detected by the detector system 208a. For example, the detector system 208a may be held by an operator (e.g., a person) and may be positioned against or near the smart glass unit 204 and/or against or near the wire(s) 206a to detect the detection signal from the controller 202a. For instance, the detector system 208a may capacitively detect, via electric field coupling, and/or inductively detect, via magnetic field coupling, the detection signal over the wire(s) associated with the smart glass unit 204a and/or adjacent (e.g., against) a pane of the smart glass unit 204a for identifying the smart glass unit 204a. In some aspects, upon detecting the detection signal, the detector system 208a may generate one or more tones through a speaker of the detection system 208a. The one or more tones may include a specific pitch assigned to the smart glass unit 204a. Additionally, or alternatively, the one or more tones may include a series of different pitches assigned to the smart glass unit 204a. Additionally, or alternatively, the one or more tones may include a sequence of pulses assigned to the smart glass unit 204a. Thus, upon detecting the detection signal, the detector system 208a may, through the speaker, project a tone or sound having a specific pitch (e.g., unique to the smart glass unit 204a), having a particular series of pitches (e.g., one or more different pitches and/or one or more same pitches) (e.g., unique to the smart glass unit 204a), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, the detecting signal may include a frequency (e.g., a sine wave, a square wave) that is unique to the smart glass unit 204a for identifying the smart glass unit 204a. Additionally, or alternatively, upon detecting the detection signal, the detector system 208a may, through the light, emit a light signal having a specific brightness or color (e.g., unique to the smart glass unit 204a), having a particular series of flashes (e.g., one or more different flashes and/or one or more same flashes) (e.g., unique to the smart glass unit 204a), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time).

The system 200 may be used to determine the location of the smart glass unit 204a with respect to an edifice or a building. For example, the controller 202a may be assigned to a location for the smart glass unit 204a. The wire(s) 206a may be electrically connected from the controller 202a and may be positioned to extend to a location associated with the controller 202a and for installing the smart glass unit 204a. Once the wire(s) 206a are connected to the controller 202a and extend to the location associated with the controller 202 (e.g., before or after the smart glass unit 204a is installed into the location associated with the controller 202a), the controller 202a may transmit a detection signal through the wire(s) 206a. The detector system 208a may capacitively or inductively detect the detection signal through the wire(s) 206a and/or the smart glass unit 204a (e.g., after the smart glass unit 204a is installed at the location and connected to the wire(s) 206a) and output an indication that a detection signal has been received. An operator (e.g., a person) holding the detector system 208a may confirm that the controller 202a is properly wired to a location associated with the controller 202a for controlling the smart glass unit 204a. Conversely, if the detector system 208a does not detect the detection signal through the wire(s) 206a and/or the smart glass unit 204a (e.g., after the smart glass unit 204a is installed at the location and connected to the wire(s) 206a) or the detector system 208a detects a different detection signal than the detection signal through the wire(s) 206a and/or the smart glass unit 204a (e.g., after the smart glass unit 204a is installed at the location and connected to the

wire(s) 206a), then the detector system 208a may not output an indication that the detection signal has been received. In this case, the operator holding the detector system 208a may confirm that the controller 202a is not properly wired to the location associated with the controller 202a for controlling the smart glass unit 204a.

In some aspects, the controller 202a may not be assigned to a particular location for the smart glass unit 204a. The wire(s) 206a may be electrically connected from the controller 202a and may be positioned to extend to an unassigned location for installing the smart glass unit 204a. Once the wire(s) 206a are connected to the controller 202a and extended to the location (e.g., before or after the smart glass unit 204a is installed at the location), the controller 202a may transmit a detection signal through the wire(s) 206a. The detector system 208a may capacitively or inductively detect the detection signal through the wire(s) 206a and/or the smart glass unit 204a (e.g., after the smart glass unit 204a is installed at the location and connected to the wire(s) 206a) and output an indication that a detection signal has been received. An operator holding the detector system 208a at the location may determine that the controller 202a is wired to the smart glass unit 204a positioned at the location where the detector system 208a detected the detection signal. The operator holding the detector system 208a may then map the controller 202a to the smart glass unit 204a at the location where the detector system 208a detected the detection signal. For example, the operator holding the detector system 208a may record that the controller 202a is mapped to the smart glass unit 204a at the location where the detector system 208a detected the detection signal and store that mapping in a data store for use by a system controller (e.g., a building automation system (BAS)). In some aspects, as described herein, the detector system 208a may automatically and/or wirelessly transmit the mapping to the data store and/or the system controller for storage and subsequent operation of the smart glass unit 204a.

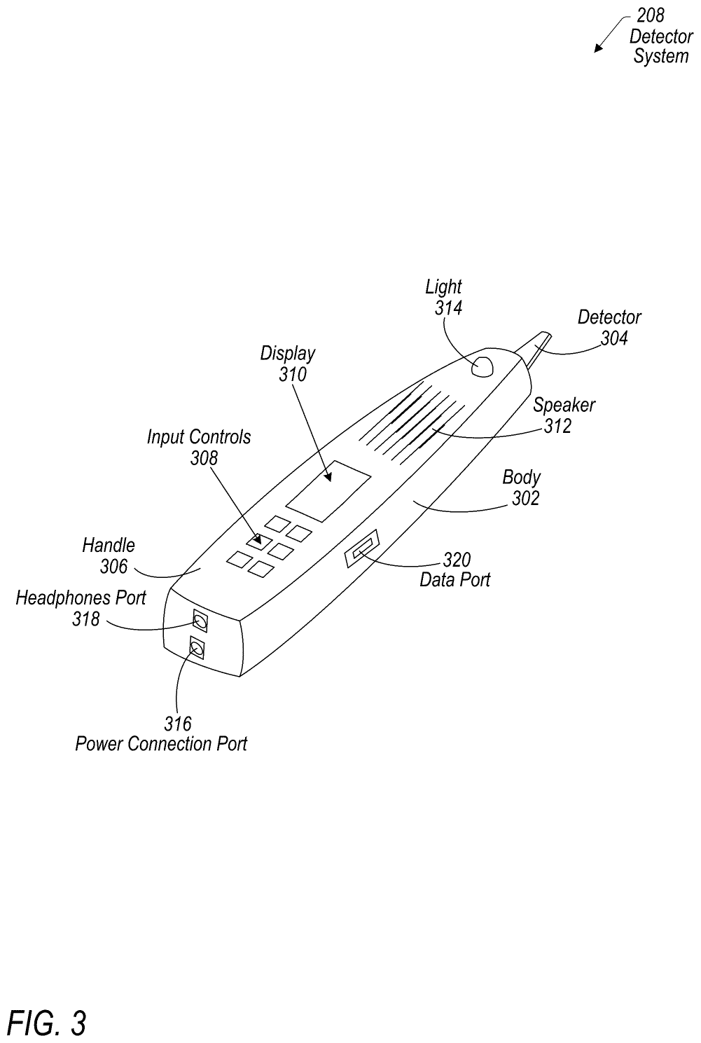

FIG. 3 illustrates a perspective view of an example detector system 208 according to some aspects of this disclosure. The detector system 208 may be implemented in any of the systems described herein including the system 200 of FIG. 2, the system 400 of FIG. 4, the system 500 of FIG. 5, and/or the computer system 1000 of FIG. 10. The detector system 208 of FIG. 3 may also implement any one or more steps described herein including one or more steps described with respect to the method 600 of FIG. 6, the method 700 of FIG. 7, the method 800 of FIG. 8, and/or the method 900 of FIG. 9. FIG. 3, as with the other included figures, is shown for illustrative purposes and does not limit either the possible embodiments of the present invention or the claims. As shown in FIG. 3, the detector system 208 may include a body 302 including a detector 304 and a handle 306. The detector 304 may be configured to capacitively detect, via electric field coupling, and/or inductively detect, via magnetic field coupling, the detection signal over the wire(s) associated with the controller 202a and/or the smart glass unit 204a and/or adjacent (e.g., against) a pane of the smart glass unit 204 for identifying the controller 202a and/or the smart glass unit 204a as described herein. The handle 306 may be configured to be grasped by an operation of the detector system 208 so that the detector system 208 may be carried by the operator to a plurality of smart glass unit locations for detecting detection signals from one or more controllers as described herein. The detector system 208 may also include one or more input controls 308. The input control(s) 308 may allow an operator to power on and power off the detector system 208, change settings of the detector system 208 (e.g., switch between capacitive detection and inductive detection, switch between audio output verification (e.g., a tone) and visual output verification (e.g., a display indication of the display screen 310, an elimination of the light 314), initiate a detection of a detection signal, initiate a determination of a location of the detector system 208, an initiate a transmission (e.g., wired or wireless) of a detection of the detection signal to a system controller, and/or the like.

The detector system 208 may also include a display 310. The display 310 may be configured to display information concerning the detector system 208. For example, the display 310 may be configured to display a power status of the detector system 208, a battery life of the detector system 208, a current setting of the detector system 208 (e.g., a capacitive detection mode, an inductive detection mode, an audio output verification mode, a visual output verification mode, an indication that the detector system 208 is detecting a detection signal, an indication that the detector system 208 is ready to detect a detection signal, an indication that a determination of a location of the detector system 208 is being initiated, an indication that a transmission (e.g., wired or wireless) of a detection of a detection signal to a system controller is initiated, an indication that a transmission (e.g., wired or wireless) of a detection of a detection signal to a system controller is complete, and/or the like. The detector system 208 may also include a speaker 312. The speaker 312 may be configured to output an audio indication that a detection signal is detected. For example, upon the detector 304 detecting a detection signal across wires (e.g., wires 206a of FIG. 2), the speaker 312 may output audio (e.g., a tone) indicating that the detection signal is detected. In some aspects, the speaker 312 may output, based on the detection signal, audio having a specific pitch associated with a smart glass unit or a controller, a series of different pitches associated with a smart glass unit or a controller, and/or a sequence of pulses associated with a smart glass unit or a controller. Thus, upon detecting the detection signal, the detector system 208 may, through the speaker 312, project a tone or sound having a specific pitch (e.g., unique to the smart glass unit 204a), having a particular series of pitches (e.g., one or more different pitches and/or one or more same pitches) (e.g., unique to a smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time).

The detector system 208 may also include a light 314. The light 314 may be configured to emit a light indicating that a detection signal is detected. For example, upon the detector 304 detecting a detection signal across wires (e.g., wires 206 of FIG. 2), the light 314 may emit light indicating that the detection signal is detected. In some aspects, the light 314 may output, based on the detection signal, light having a specific brightness associated with a smart glass unit or a controller, a series of light flashes have different levels of brightness associated with a smart glass unit or a controller, and/or a sequence of light pulses associated with a smart glass unit or a controller. Thus, upon detecting the detection signal, the detector system 208 may, through the light 314, project a light having a specific brightness (e.g., unique to the smart glass unit 204a), having a particular series of light flashes (e.g., one or more different flashes and/or one or more same flashes) (e.g., unique to a smart glass unit), and/or having a sequence of light pulses (e.g., that individually last for one or more same amounts of time and/or one or more different amounts of time, that are spaced by breaks that last for one or more same amounts of time and/or one or more different amounts of time, that in total have a duration that lasts for a unique amount of time).

In some aspects, the detector system 208 may include a haptic device contained with the body 302 that vibrates the body 302 of the detector system 208. For example, upon detecting the detection signal, the detector system may, through the haptic device within the detector system 208, vibrate according a specific frequency (e.g., unique to the smart glass unit), according to a particular series of vibrations (e.g., unique to the smart glass unit), and/or according to a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time).

The detector system 208 may also include a power connection port 316 for receiving an electrical line to charge an internal battery of the detector system 208 for powering the detector system 208. In addition, the detector system 208 may include a headphones port 318 to receive headphones for outputting sound therethrough as an alternative to or in addition to the speaker 312. The detector system 208 may include a data port 320 for receiving a data communication line. The data port 320 may connect the detector system 208 to a data storage (e.g., the system memory 1020 of FIG. 10, the data 1026 of FIG. 10) for storing records mapping particular smart glass units, with particular locations, and/or with particular controllers, as described herein. In some aspects, the data port 320 may connect the detector system 208 to a wireless communication device (e.g., the computer system 1000 of FIG. 10, a portable device 1080 of FIG. 10) for transmitting an indication of a detection signal and a location of the detector system 208 and the time the detection signal was detecting to a data storage (e.g., the system memory 1020 of FIG. 10, the data 1026 of FIG. 10) and/or a system controller (e.g., the system controller 501 of FIG. 5, the computer system 1000 of FIG. 10) for mapping particular smart glass units, with particular location, and/or with particular controllers, as described herein. In some aspects, the detector system 208 may include a controller (e.g., the computer system 1000 of FIG. 10) for identifying a detection signal received by the detector 304 and determining a location of the detector system 208 at the time the detection signal was detected. In some aspects, the detector system 208 may include a wireless transmitter or transceiver for transmitting an indication of a detection signal and a location of the detector system 208 at the time the detection signal was detecting to a data storage (e.g., the system memory 1020 of FIG. 10, the data 1026 of FIG. 10) and/or a system controller (e.g., the system controller 501 of FIG. 5, the computer system 1000 of FIG. 10) for mapping particular smart glass units, with particular location, and/or with particular controllers, as described herein. In some aspects, the detector system 208 may include an application installed in a memory of a portable electronic device (e.g., the computer system 1000 of FIG. 10, a portable device 1080 of FIG. 10). The portable electronic device may be connected to the detector 304 (and/or the detector system 208) and may include a wireless transmitter or transceiver. The detector system 208 may use the portable electronic device for transmitting, via the wireless transmitter or transceiver, an indication of a detection signal detected by the detector 304 and a location of the portable electronic device and the time the detection signal was detecting to a data storage (e.g., the system memory 1020 of FIG. 10, the data 1026 of FIG. 10) and/or a system controller (e.g., the system controller 501 of FIG. 5, the computer system 1000 of FIG. 10) for mapping particular smart glass units, with particular location, and/or with particular controllers, as described herein. Thus, using one or more of the features of the detector system 208, as described herein, the detector system 208 may carried around by an operator to a plurality of smart glass unit locations for detecting detection signals from one or more controllers for mapping individual smart glass units, individual locations for positioning smart glass units, and/or individual controllers together.

FIG. 4 illustrates a block diagram of an example system 400 according to some aspects of this disclosure. The system 400 may include one or more same or similar features as the features described with respect to or illustrated in FIGS. 1, 2, 5, and 10. For example, the system 400 may include one or more same or similar features as the features described with respect to the EC system 100 of FIG. 1, the system 200 of FIG. 2, the system 500 of FIG. 5, and/or the computer system 1000 of FIG. 10. The system 400 of FIG. 4 may also implement any one or more steps described herein including one or more steps described with respect to the method 600 of FIG. 6, the method 700 of FIG. 7, the method 800 of FIG. 8, and/or the method 900 of FIG. 9. FIG. 4, as with the other included figures, is shown for illustrative purposes and does not limit either the possible embodiments of the present invention or the claims.

As shown in FIG. 4, the system 400 includes a controller 402, a first smart glass unit 404a, a second smart glass unit 404b, a first set of wires 406a, a second set of wires 406b, and the detector system 208. The first smart glass unit 404a and/or the second smart glass unit 404b may include one or more features of the EC device 100 illustrated in FIG. 1. The first smart glass unit 404a and/or the second smart glass unit 404b may be positioned within an interior or an exterior wall of an edifice or building for viewing therethrough. The controller 402 may be located within and/or near at least one of the first smart glass unit 404a and/or the second smart glass unit 404b. For example, the controller 402 may be integrated within a panel of the first smart glass unit 404a. As another example, the controller 402 may be positioned adjacent or next to the second smart glass unit 404b, but further away from the first smart glass unit 404a. As yet another example, the controller 402 may be positioned within a wall adjacent, next to, or near the first smart glass unit 404a, but further away from the second smart glass unit 404b. Alternatively, the controller 402 may be located a distance away from all of the first smart glass unit 404a and/or the second smart glass unit 404b. For example, the controller 402 may be located within a room of a building that does not include the first smart glass unit 404a and/or the second smart glass unit 404b. As another example, the controller 402 may be located above a ceiling or below a floor within a room that includes at least one of the first smart glass unit 404a and/or the second smart glass unit 404b. As yet another example, the controller 402 may be located in another building that does not include the first smart glass unit 404a and/or the second smart glass unit 404b.

The first smart glass unit 404a may be electrically connected to the controller 402 via the first set of wires 406a. Similarly, the second smart glass unit 404b may be electrically connected to the controller 402 via the second set of wires 406b. The wire(s) 406 may electrically connect both the controller 402 and the respective smart glass units 404 so that the wire(s) 406 may communicate signals from the controller 402 to the respective smart glass units 404. For example, the controller 402 may generate and transmit individual and/or unique tint control signals, via the respective wire(s) 406, to the respective smart glass units 404 to increase, decrease, or maintain a tint level of the respective smart glass units 404. As another example, the controller 402 may generate and transmit individual and/or unique smart glass unit detection signals, via the respective wire(s) 406 and independent of any other type of signal including a tint control signal, for detection of the respective smart glass units 404. The smart glass unit detection signal(s) may be a signal that does not control a tint level of any of the respective smart glass units 404.

It should be understood that the controller 402 may transmit both the respective tint control signal(s) and the smart glass unit detection signals over the same respective wire(s) 406 for the respective smart glass units 404 at the same time or at different times. For example, the controller 402 may transmit a first tint control signal to the first smart glass unit 404a using the first set of wires 406a and subsequently transmit a first smart glass unit detection signal to the first smart glass unit 404a using the first set of wires 406a. As another example, the controller 402 may transmit a second tint control signal to the second smart glass unit 404b using the second set of wires 406b while at the same time transmitting a second smart glass unit detection signal to the second smart glass unit 404b using the second set of wires 406b. As yet another example, the controller 402 may transmit a third tint control signal to the first smart glass unit 404a using the first set of wires 406d after transmitting a third smart glass unit detection signal to the first smart glass unit 404a using the first set of wires 406a.

In some aspects, the smart glass unit detection signal may be detected by the detector system 208. For example, the controller 402 may transmit a detection signal over the first set of wires 406a to the first smart glass unit 404a. The detector system 208 may be held by an operator (e.g., a person) and may be positioned against or near the first smart glass unit 404a and/or against or near the first set of wires 406a to detect the detection signal from the controller 402. The detector system 208 may capacitively detect, via electric field coupling, and/or inductively detect, via magnetic field coupling, the detection signal over the first set of wires 406a associated with the first smart glass unit 404a and/or adjacent (e.g., against) a pane of the first smart glass unit 404a for identifying the first smart glass unit 404a. As described herein, the detector system 208 may provide an indication (e.g., a tone, a sound, a light, a vibration or the like) when the detector system 208 detects the detection signal at the first smart glass unit 404a and/or over the first set of wires 406a. Upon the detector system 208 providing the indication, an operator (e.g., a person) holding the detector system 208 may confirm that the controller 402 is properly wired to a location associated with a particular port of the controller 402 for controlling the first smart glass unit 404a. Alternatively, an operator holding the detector system 208 at the location may determine that the controller 402 is wired to the first smart glass unit 404a positioned at the location where the detector system 208 detected the detection signal. The operator holding the detector system 208 may then map a particular port of the controller 402 to the first smart glass unit 404a at the location where the detector system 208 detected the detection signal.

In some aspects, controller 402 may subsequently transmit the same detection signal over the second set of wires 406b to the second smart glass unit 404b. The detector system 208 may be held by an operator (e.g., a person) and may be positioned against or near the second smart glass unit 404b and/or against or near the second set of wires 406b to detect the detection signal from the controller 402. The detector system 208 may capacitively detect, via electric field coupling, and/or inductively detect, via magnetic field coupling, the detection signal over the second set of wires 406b associated with the second smart glass unit 404b and/or adjacent (e.g., against) a pane of the second smart glass unit 404b for identifying the second smart glass unit 404b. As described herein, the detector system 208 may provide an indication (e.g., a tone, a sound, a light, a vibration, or the like) when the detector system 208 detects the detection signal at the second smart glass unit 404b and/or over the second set of wires 406b. Upon the detector system 208 providing the indication, an operator (e.g., a person) holding the detector system 208 may confirm that the controller 402 is properly wired to a location associated with a particular port of the controller 402 for controlling the second smart glass unit 404b. Alternatively, an operator holding the detector system 208 at the location may determine that the controller 402 is wired to the second smart glass unit 404b positioned at the location where the detector system 208 detected the detection signal. The operator holding the detector system 208 may then map a particular port of the controller 402 to the second smart glass unit 404b at the location where the detector system 208 detected the detection signal.

As described herein, the controller 402 may be configured to generate and transmit different and/or unique detection signals to respective smart glass units 404 for detecting or identifying respective smart glass units. For example, the controller 402 may be configured to generate different and/or unique detection signals for producing a unique and/or different indication by the detector system 208. For instance, the controller 402 may generate a first detection signal for producing a tone or sound, via the detector system 208, having a specific pitch (e.g., unique to the first smart glass unit 404a), having a particular series of pitches (e.g., unique to the first smart glass unit 404a), and/or having a sequence of pulses (e.g., unique to the first smart glass unit 404a) (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, the first detecting signal may include a frequency (e.g., a sine wave, a square wave) that is detected by the detector system 208 and is unique to the first smart glass unit 404a for identifying the first smart glass unit 404a. Additionally, or alternatively, the controller 402 may generate a first detection signal for emitting a light signal, via the detector system 208, having a specific brightness or color (e.g., unique to the first smart glass unit 404a), having a particular series of flashes (e.g., one or more different flashes and/or one or more same flashes) (e.g., unique to the first smart glass unit 404a), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, a controller may transmit a detection signal(s) such that multiple frequencies are simultaneously received by a single smart glass unit. For example, a controller may transmit a detection signal(s) that includes a dual-tone multi-frequency (DTMF) signal.

At the same time, or subsequently, the controller 402 may generate a second detection signal different from the first detection signal and for producing a tone or sound having a specific pitch (e.g., unique to the second smart glass unit 404b), having a particular series of pitches (e.g., unique to the second smart glass unit 404b), and/or having a sequence of pulses (e.g., unique to the second smart glass unit 404b) (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, the second detecting signal may include a different frequency (e.g., a sine wave, a square wave) that is unique to the second smart glass unit 404b for identifying the second smart glass unit 404a. Additionally, or alternatively, the controller 402 may generate a second detection signal for emitting a different light signal, via the detector system 208, having a specific brightness or color (e.g., unique to the second smart glass unit 404b), having a particular series of flashes (e.g., one or more different flashes and/or one or more same flashes) (e.g., unique to the second smart glass unit 404b), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time).

The system 400 may be used to determine the location of the first smart glass unit 404a with respect to an edifice or a building and the location of the second smart glass unit 404b with respect to an edifice or a building. For example, a port of the controller 402 may be assigned to a first location for the first smart glass unit 404a. The first set of wires 406a may be electrically connected from the port of the controller 402 and may be positioned to extend to the location associated with the port of the controller 402 for installing the first smart glass unit 404a. Once the first set of wires 406a are connected to the particular port of the controller 402 and extend to the location associated with the particular port of the controller 402 (e.g., before or after the first smart glass unit 404a is installed into the location associated with the controller 402), the controller 402 may transmit the first detection signal through the first set of wires 406a. The detector system 208 may capacitively or inductively detect the first detection signal through the first set of wires 406a and/or the first smart glass unit 404a (e.g., after the first smart glass unit 404a is installed at the location and connected to the first set of wires 406a) and output an indication that the first detection signal has been received. An operator (e.g., a person) holding the detector system 208 may confirm that the particular port of the controller 402 is properly wired to a location associated with the particular port of the controller 402 for controlling the first smart glass unit 404a. Conversely, if the detector system 208 does not detect the first detection signal through the first set of wires 406a and/or the first smart glass unit 404a (e.g., after the first smart glass unit 404a is installed at the location and connected to the first set of wires 406a) or the detector system 208 detects a different detection signal than the first detection signal through the first set of wires 406a and/or the first smart glass unit 404a (e.g., after the first smart glass unit 404a is installed at the location and connected to the first set of wires 406a), then the detector system 208 may not output an indication that the first detection signal has been received. In this case, the operator holding the detector system 208 may confirm that the controller 402 is not properly wired to the location associated with the port of the controller 402 for controlling the first smart glass unit 404a.

Similarly, the system 400 may be used to determine the location of the second smart glass unit 404b with respect to an edifice or a building. For example, another port of the controller 402 may be assigned to a second location for the second smart glass unit 404b. The second set of wires 406b may be electrically connected from the other port of the controller 402 and may be positioned to extend to the location associated with the second smart glass unit 404b and for installing the second smart glass unit 404b. Once the second set of wires 406b are connected to the other port of the controller 402 and extend to the location associated with the particular port of the controller 402 (e.g., before or after the second smart glass unit 404b is installed into the location associated with the controller 402), the controller 402 may transmit the second detection signal through the second set of wires 406b. The detector system 208 may capacitively or inductively detect the second detection signal through the second set of wires 406b and/or the second smart glass unit 404b (e.g., after the second smart glass unit 404b is installed at the location and connected to the second set of wires 406b) and output an indication that the second detection signal has been received. An operator (e.g., a person) holding the detector system 208 may confirm that the particular port of the controller 402 is properly wired to a location associated with the particular port of the controller 402 for controlling the second smart glass unit 404b. Conversely, if the detector system 208 does not detect the second detection signal through the second set of wires 406b and/or the second smart glass unit 404b (e.g., after the second smart glass unit 404b is installed at the location and connected to the second set of wires 406b) or the detector system 208 detects a different detection signal than the second detection signal through the second set of wires 406b and/or the second smart glass unit 404b (e.g., after the second smart glass unit 404b is installed at the location and connected to the second set of wires 406b), then the detector system 208 may not output an indication that the second detection signal has been received. In this case, the operator holding the detector system 208 may confirm that the controller 402 is not properly wired to the location associated with the port of the controller 402 for controlling the second smart glass unit 404b.

In some aspects, a port of the controller 402 may not be assigned to a particular location for the first smart glass unit 404a. The first set of wires 406a may be electrically connected from the port of the controller 402 and may be positioned to extend to an unassigned location for installing the first smart glass unit 404a. Once the first set of wires 406a are connected to the port of the controller 402 and extended to the location (e.g., before or after the first smart glass unit 404a is installed at the location), the controller 402 may transmit a first detection signal through the first set of wires 406a. The detector system 208 may capacitively or inductively detect the first detection signal through the first set of wires 406a and/or the first smart glass unit 404a (e.g., after the first smart glass unit 404a is installed at the location and connected to the first set of wires 406a) and output an indication that the first detection signal has been received. An operator holding the detector system 208 at the location may determine that the controller 402 is wired to the first smart glass unit 404a positioned at the location where the detector system 208 detected the detection signal. The operator holding the detector system 208 may then map the port of the controller 402 to the first smart glass unit 404a at the location where the detector system 208 detected the detection signal. For example, the operator holding the detector system 208 may record that the port of the controller 402 is mapped to the first smart glass unit 404a at the location where the detector system 208 detected the first detection signal and store that mapping in a data store for use by a system controller (e.g., a building automation system (BAS)). In some aspects, as described herein, the detector system 208 may automatically and/or wirelessly transmit the mapping to the data store and/or the system controller for storage and subsequent operation of the first smart glass unit 404a.

In some aspects, another port of the controller 402 may not be assigned to a particular location for the second smart glass unit 404b. The second set of wires 406b may be electrically connected from the other port of the controller 402 and may be positioned to extend to an unassigned location for installing the second smart glass unit 404b. Once the second set of wires 406b are connected to the other port of the controller 402 and extended to the location (e.g., before or after the second smart glass unit 404b is installed at the location), the controller 402 may transmit a second detection signal through the second set of wires 406b. The detector system 208 may capacitively or inductively detect the second detection signal through the second set of wires 406b and/or the second smart glass unit 404b (e.g., after the second smart glass unit 404b is installed at the location and connected to the second set of wires 406b) and output an indication that the second detection signal has been received. An operator holding the detector system 208 at the location may determine that the controller 402 is wired to the second smart glass unit 404b positioned at the location where the detector system 208 detected the detection signal. The operator holding the detector system 208 may then map the other port of the controller 402 to the second smart glass unit 404b at the location where the detector system 208 detected the detection signal. For example, the operator holding the detector system 208 may record that the other port of the controller 402 is mapped to the second smart glass unit 404b at the location where the detector system 208 detected the second detection signal and store that mapping in a data store for use by a system controller (e.g., a building automation system (BAS)). In some aspects, as described herein, the detector system 208 may automatically and/or wirelessly transmit the mapping to the data store and/or the system controller for storage and subsequent operation of the second smart glass unit 404b.

FIG. 5 illustrates a block diagram of an example system 500 according to some aspects of this disclosure. The system 500 may include one or more same or similar features as the features described with respect to or illustrated in FIGS. 1, 2, 4, and 10. For example, the system 500 may include one or more same or similar features as the features described with respect to the EC system 100 of FIG. 1, the system 200 of FIG. 2, the system 400 of FIG. 4, and/or the computer system 1000 of FIG. 10. The system 500 of FIG. 5 may also implement any one or more steps described herein including one or more steps described with respect to the method 600 of FIG. 6, the method 700 of FIG. 7, the method 800 of FIG. 8, and/or the method 900 of FIG. 9. FIG. 2, as with the other included figures, is shown for illustrative purposes and does not limit either the possible embodiments of the present invention or the claims.

As shown in FIG. 5, the system 500 includes a system controller 501, a first controller 502a, a second controller 502b, a first smart glass unit 504a, a second smart glass unit 504b, a third smart glass unit 504c, a first set of wires 506a, a second set of wires 506b, a third set of wires 506c, and the detector system 208. The system controller 501, the first controller 502a, the second controller 502b, and/or the detector system 208 may include one or more same or similar features as the computer system 1000 of FIG. 10. The first smart glass unit 504a, the second smart glass unit 504b, and the third smart glass unit 504c may include one or more features of the EC device 100 illustrated in FIG. 1.

The system controller 501 may be positioned at a location within a building or at a remote location for communicating (e.g., via wires, via wireless connections) with the first controller 502a and the second controller 502b. The system controller 501 may be configured to transmits command signals to the first controller 502a and the second controller 502b. For example, the system controller 501 may be configured to transmit a command signal to the first controller 502a instructing the first controller 502a to transmit a tint control signal, as described herein, to the first smart glass unit 504a and/or the second smart glass unit 504b. Before, during, and/or after the system controller 501 transmits a command signal to the first controller 502a instructing the first controller 502a to transmit a tint control signal to the first smart glass unit 504a and/or the second smart glass unit 504b, the system controller 501 may also be configured to transmit another command signal to the first controller 502a instructing the first controller 502a to transmit a smart glass unit detection signal, as described herein, to the first smart glass unit 504a and/or the second smart glass unit 504b. Similarly, the system controller 501 may be configured to transmit a command signal to the second controller 502b instructing the second controller 502b to transmit a tint control signal, as described herein, to the third smart glass unit 504c. Before, during, and/or after the system controller 501 transmits a command signal to the second controller 502b instructing the second controller 502b to transmit a tint control signal to the third smart glass unit 504c, the system controller 501 may also be configured to transmit another command signal to the second controller 502b instructing the second controller 502b to transmit a smart glass unit detection signal, as described herein, to the third smart glass unit 504c.

In some aspects, the system controller 501 is configured to receive data mapping controllers to the smart glass units, mapping ports of particular controllers to smart glass units, and/or mapping controllers to particular locations including smart glass units. For example, upon the detector system 208 detecting a detector signal at or near a location associated with a smart glass unit, an operator (e.g., a person) of the detector system 208 and/or the detector system 208 itself (e.g., via wireless transmission) may transmit data to the system controller 501 mapping a particular location of the smart glass unit receiving the detection signal with a particular controller or a particular data port of the controller. The system controller 501 may receive the data and store the data in a data store (e.g., system memory 1020 of FIG. 10, data 1026 of FIG. 10) for subsequent tint control of the smart glass unit located at the particular position. For example, using the data mapping controllers to the smart glass units, mapping ports of particular controllers to smart glass units, and/or mapping controllers to particular locations including smart glass units, the system controller 501 may transmit command signals to the respective controllers to maintain and/or change tint levels of the respective smart glass units.

The first smart glass unit 504a, the second smart glass unit 504b, and/or the third smart glass unit 504c may be positioned within an interior or an exterior wall of an edifice or building for viewing therethrough. The first controller 502a may be located within and/or near at least one of the first smart glass unit 504a and/or the second smart glass unit 504b. For example, the first controller 502a may be integrated within a panel of the first smart glass unit 504a. As another example, the first controller 502a may be positioned adjacent or next to the second smart glass unit 504b, but further away from the first smart glass unit 504a. As yet another example, the first controller 502a may be positioned within a wall adjacent, next to, or near the first smart glass unit 504a, but further away from the second smart glass unit 504b. Alternatively, the first controller 502a may be located a distance away from all of the first smart glass unit 504a and/or the second smart glass unit 504b. For example, the first controller 502a may be located within a room of a building that does not include the first smart glass unit 504a and/or the second smart glass unit 504b. As another example, the first controller 502a may be located above a ceiling or below a floor within a room that includes at least one of the first smart glass unit 504a and/or the second smart glass unit 504b. As yet another example, the first controller 502a may be located in another building that does not include the first smart glass unit 504a and/or the second smart glass unit 504b.

Similarly, the second controller 502b may be located within and/or near the third smart glass unit 504c. For example, the second controller 502b may be integrated within a panel of the third smart glass unit 504c. As another example, the second controller 502b may be positioned adjacent or next to the third smart glass unit 504c. Alternatively, the second controller 502b may be located a distance away from the third smart glass unit 504c. For example, the second controller 502b may be located within a room of a building that does not include the third smart glass unit 504c. As another example, the second controller 502b may be located above a ceiling or below a floor within a room that includes the third smart glass unit 504c. As yet another example, the second controller 502b may be located in another building that does not include the third smart glass unit 504c.

The first smart glass unit 504a may be electrically connected to the first controller 502a via the first set of wires 506a. Similarly, the second smart glass unit 504b may be electrically connected to the first controller 502a via the second set of wires 506b. In addition, the third smart glass unit 504c may be electrically connected to the second controller 502b via the third set of wires 506c. The wire(s) 506 may electrically connect the respective controllers 502 and the respective smart glass units 504 so that the wire(s) 506 may communicate signals from the respective controllers 502 to the respective smart glass units 504. For example, the respective controllers 502 may generate and transmit individual and/or unique tint control signals, via the respective wire(s) 506, to the respective smart glass units 504 to increase, decrease, or maintain a tint level of the respective smart glass units 504. As another example, the respective controllers 502 may generate and transmit individual and/or unique smart glass unit detection signals, via the respective wire(s) 506 and independent of any other type of signal including a tint control signal, for detection of the respective smart glass units 504. The smart glass unit detection signal(s) may be a signal that does not control a tint level of any of the respective smart glass units 504.

It should be understood that the respective controllers 502 may transmit both the respective tint control signal(s) and the smart glass unit detection signals over the same respective wire(s) 506 for the respective smart glass units 504 at the same time or at different times. For example, the first controller 502a may transmit a first tint control signal to the first smart glass unit 504a using the first set of wires 506a and subsequently transmit a first smart glass unit detection signal to the first smart glass unit 504a using the first set of wires 506a. As another example, the first controller 502a may transmit a second tint control signal to the second smart glass unit 504b using the second set of wires 506b while at the same time transmitting a second smart glass unit detection signal to the second smart glass unit 504b using the second set of wires 506b. As yet another example, the second controller 502b may transmit a third tint control signal to the third smart glass unit 504c using the third set of wires 506c after transmitting a third smart glass unit detection signal to the third smart glass unit 504c using the third set of wires 506c.

In some aspects, the smart glass unit detection signal may be detected by the detector system 208. For example, the first controller 502a may receive a command signal from the system controller 501, via wireless transmission and/or via wired transmission, to transmit a detection signal to the first smart glass unit 504a and subsequently transmit the detection signal over the first set of wires 506a to the first smart glass unit 504a. The detector system 208 may be held by an operator (e.g., a person) and may be positioned against or near the first smart glass unit 504a and/or against or near the first set of wires 506a to detect the detection signal from the first controller 502a. The detector system 208 may capacitively detect, via electric field coupling, and/or inductively detect, via magnetic field coupling, the detection signal over the first set of wires 506a associated with the first smart glass unit 504a and/or adjacent (e.g., against) a pane of the first smart glass unit 504a for identifying the first smart glass unit 504a. As described herein, the detector system 208 may provide an indication (e.g., a tone, a sound, a light, a vibration, or the like) when the detector system 208 detects the detection signal at the first smart glass unit 504a and/or over the first set of wires 506a. Upon the detector system 208 providing the indication, an operator (e.g., a person) holding the detector system 208 may confirm that the first controller 502a is properly wired to a location associated with the first controller 502a and/or a particular port of the first controller 502a for controlling the first smart glass unit 504a. Alternatively, an operator holding the detector system 208 at the location may determine that the first controller 502a is wired to the first smart glass unit 504a positioned at the location where the detector system 208 detected the detection signal. The operator holding the detector system 208 may then map the first controller 502a and/or a particular port of the first controller 502a to the first smart glass unit 504a at the location where the detector system 208 detected the detection signal.

In some aspects, the smart glass unit detection signal may be detected by the detector system 208. For example, the first controller 502a may receive a command signal from the system controller 501, via wireless transmission and/or via wired transmission, to transmit a detection signal to the second smart glass unit 504b and subsequently transmit the detection signal over the second set of wires 506b to the second smart glass unit 504b. The detector system 208 may be held by an operator (e.g., a person) and may be positioned against or near the second smart glass unit 504b and/or against or near the second set of wires 506b to detect the detection signal from the first controller 502a. The detector system 208 may capacitively detect, via electric field coupling, and/or inductively detect, via magnetic field coupling, the detection signal over the second set of wires 506b associated with the second smart glass unit 504b and/or adjacent (e.g., against) a pane of the second smart glass unit 504b for identifying the second smart glass unit 504b. As described herein, the detector system 208 may provide an indication (e.g., a tone, a sound, a light, or the like) when the detector system 208 detects the detection signal at the second smart glass unit 504b and/or over the second set of wires 506b. Upon the detector system 208 providing the indication, an operator (e.g., a person) holding the detector system 208 may confirm that the first controller 502a is properly wired to a location associated with the first controller 502a and/or another particular port of the first controller 502a for controlling the second smart glass unit 504b. Alternatively, an operator holding the detector system 208 at the location may determine that the first controller 502a is wired to the second smart glass unit 504b positioned at the location where the detector system 208 detected the detection signal. The operator holding the detector system 208 may then map the first controller 502a and/or another particular port of the first controller 502a to the second smart glass unit 504b at the location where the detector system 208 detected the detection signal. In some aspects, the system controller 501 may send a command signal to the first controller 502a instructing the first controller 502a to send the same detection signal to both the first smart glass unit 504a and the second smart glass unit 504b sequentially or simultaneously to confirm that the first controller 502a is properly wired to a location associated with the first controller 502a for controlling the first smart glass unit 504a and the second smart glass unit 504b, for example, together. In some aspects, the system controller 501 may send a command signal to the first controller 502a instructing the first controller 502a to send different detection signals, as described herein, to the first smart glass unit 504a and the second smart glass unit 504b sequentially or simultaneously to confirm that the first controller 502a is properly wired to a location associated with a particular port of the first controller 502a for controlling the first smart glass unit 504a and to confirm that the first controller 502a is properly wired to a location associated with another particular port of the first controller 502a for controlling the second smart glass unit 504b.

In some aspects, the smart glass unit detection signal may be detected by the detector system 208. For example, the second controller 502b may receive a command signal from the system controller 501, via wireless transmission and/or via wired transmission, to transmit a detection signal to the third smart glass unit 504c and subsequently transmit the detection signal over the third set of wires 506c to the third smart glass unit 504c. The detector system 208 may be held by an operator (e.g., a person) and may be positioned against or near the third smart glass unit 504c and/or against or near the third set of wires 506c to detect the detection signal from the second controller 502b. The detector system 208 may capacitively detect, via electric field coupling, and/or inductively detect, via magnetic field coupling, the detection signal over the third set of wires 506c associated with the third smart glass unit 504c and/or adjacent (e.g., against) a pane of the third smart glass unit 504c for identifying the third smart glass unit 504c. As described herein, the detector system 208 may provide an indication (e.g., a tone, a sound, a light, a vibration, or the like) when the detector system 208 detects the detection signal at the third smart glass unit 504c and/or over the third set of wires 506c. Upon the detector system 208 providing the indication, an operator (e.g., a person) holding the detector system 208 may confirm that the second controller 502b is properly wired to a location associated with the second controller 502b and/or a particular port of the second controller 502b for controlling the third smart glass unit 504c. Alternatively, an operator holding the detector system 208 at the location may determine that the second controller 502b is wired to the third smart glass unit 504c positioned at the location where the detector system 208 detected the detection signal. The operator holding the detector system 208 may then map the second controller 502b and/or a particular port of the second controller 502b to the third smart glass unit 504c at the location where the detector system 208 detected the detection signal. In some aspects, the system controller 501 may send a first command signal to the first controller 502a and a second command signal to the second controller 502b instructing the respective controllers to send different detection signals. For example, the system controller 501 may send a command signal to the first controller 502a instructing the first controller 502a to send a first detection signal to the first smart glass unit 504a and the second smart glass unit 504b. The system controller 501 may also send a command signal to second controller 502b instructing the second controller 502b to send a second and different detection signal (e.g., compared to the first detection signal) to the third smart glass unit 504c. This may allow for concurrent mapping of smart glass units and/or smart glass unit locations to particular controllers. In some aspects, the system controller 501 may send a first command signal to the first controller 502a and a second command signal to the second controller 502b instructing the respective controllers to send different detection signals to each of the respective smart glass units. For example, the system controller 501 may send a command signal to the first controller 502a instructing the first controller 502a to send a first detection signal to the first smart glass unit and a second and different detection signal to the second smart glass unit 504b. The system controller 501 may also send a command signal to second controller 502b instructing the second controller to send a third detection signal, different from the first detection signal and the second detection signal, to the third smart glass unit 504c. This may allow for concurrent mapping of smart glass units and/or smart glass unit locations to particular ports of the respective controllers.

The system 500 may be used to determine the location of the first smart glass unit 504a with respect to an edifice or a building. For example, a port of the first controller 502a may be assigned to a first location for the first smart glass unit 504a. The first set of wires 506a may be electrically connected from the port of the first controller 502a and may be positioned to extend to the location associated with the port of the first controller 502a for installing the first smart glass unit 504a. Once the first set of wires 506a are connected to the particular port of the first controller 502a and extend to the location for the first smart glass unit 504a and associated with the particular port of the first controller 502a (e.g., before or after the first smart glass unit 504a is installed into the location), the first controller 502a may transmit the first detection signal through the first set of wires 506a. The detector system 208 may capacitively or inductively detect the first detection signal through the first set of wires 506a and/or the first smart glass unit 504a (e.g., after the first smart glass unit 504a is installed at the location and connected to the first set of wires 506a) and output an indication that the first detection signal has been received. An operator (e.g., a person) holding the detector system 208 may confirm that the particular port of the first controller 502a is properly wired to a location associated with the particular port of the first controller 502a for controlling the first smart glass unit 504a. Conversely, if the detector system 208 does not detect the first detection signal through the first set of wires 506a and/or the first smart glass unit 504a (e.g., after the first smart glass unit 504a is installed at the location and connected to the first set of wires 506a) or the detector system 208 detects a different detection signal different from the first detection signal through the first set of wires 506a and/or the first smart glass unit 504a (e.g., after the first smart glass unit 504a is installed at the location and connected to the first set of wires 506a), then the detector system 208 may not output an indication that the first detection signal has been received. In this case, the operator holding the detector system 208 may confirm that the first controller 502a is not properly wired to the location associated with the port of the first controller 502a for controlling the first smart glass unit 504a.

Similarly, the system 500 may be used to determine the location of the second smart glass unit 504b with respect to an edifice or a building. For example, another port of the first controller 502a may be assigned to a second location for the second smart glass unit 504b. The second set of wires 506b may be electrically connected from the other port of the first controller 502a and may be positioned to extend to the location associated with the other port of the first controller 502a for installing the second smart glass unit 504b. Once the second set of wires 506b are connected to the particular other port of the first controller 502a and extend to the location for the second smart glass unit 504b and associated with the particular other port of the first controller 502a (e.g., before or after the second smart glass unit 504b is installed into the location), the first controller 502a may transmit the second detection signal through the second set of wires 506b. The detector system 208 may capacitively or inductively detect the second detection signal through the second set of wires 506b and/or the second smart glass unit 504b (e.g., after the second smart glass unit 504b is installed at the location and connected to the second set of wires 506b) and output an indication that the second detection signal has been received. An operator (e.g., a person) holding the detector system 208 may confirm that the particular other port of the first controller 502a is properly wired to a location associated with the particular other port of the first controller 502a for controlling the second smart glass unit 504b. Conversely, if the detector system 208 does not detect the second detection signal through the second set of wires 506b and/or the second smart glass unit 504b (e.g., after the second smart glass unit 504b is installed at the location and connected to the second set of wires 506b) or the detector system 208 detects a different detection signal different from the second detection signal through the second set of wires 506b and/or the second smart glass unit 504b (e.g., after the second smart glass unit 504b is installed at the location and connected to the second set of wires 506b), then the detector system 208 may not output an indication that the second detection signal has been received. In this case, the operator holding the detector system 208 may confirm that the first controller 502a is not properly wired to the location associated with the other port of the first controller 502a for controlling the second smart glass unit 504b.

Similarly, the system 500 may be used to determine the location of the third smart glass unit 504c with respect to an edifice or a building. For example, the second controller 502b may be assigned to a third location for the third smart glass unit 504c. The third set of wires 506c may be electrically connected from the second controller 502b and may be positioned to extend to the location associated with the second controller 502b for installing the third smart glass unit 504c. Once the third set of wires 506c are connected to the second controller 502b and extend to the location for the third smart glass unit 504c and associated with the second controller 502b (e.g., before or after the third smart glass unit 504c is installed into the location), the second controller 502b may transmit the third detection signal through the third set of wires 506c. The detector system 208 may capacitively or inductively detect the third detection signal through the third set of wires 506c and/or the third smart glass unit 504c (e.g., after the third smart glass unit 504c is installed at the location and connected to the third set of wires 506c) and output an indication that the third detection signal has been received. An operator (e.g., a person) holding the detector system 208 may confirm that the second controller 502b is properly wired to a location associated with the second controller 502b for controlling the third smart glass unit 504c. Conversely, if the detector system 208 does not detect the third detection signal through the third set of wires 506c and/or the third smart glass unit 504c (e.g., after the third smart glass unit 504c is installed at the location and connected to the third set of wires 506c) or the detector system 208 detects a different detection signal different from the third detection signal through the third set of wires 506c and/or the third smart glass unit 504c (e.g., after the third smart glass unit 504c is installed at the location and connected to the third set of wires 506c), then the detector system 208 may not output an indication that the third detection signal has been received. In this case, the operator holding the detector system 208 may confirm that the second controller 502b is not properly wired to the location associated with the second controller 502b for controlling the third smart glass unit 504c.

In some aspects, a port of a controller 502 or a controller 502 itself may not be assigned to a particular location for smart glass unit. For example, a port of the first controller 502a may not be assigned to a particular location for the first smart glass unit 504a. The first set of wires 506a may be electrically connected from the port of the first controller 502a and may be positioned to extend to an unassigned location for installing the first smart glass unit 504a. Once the first set of wires 506a are connected to the port of the first controller 502a and extended to the location (e.g., before or after the first smart glass unit 504a is installed at the location), the first controller 502a may transmit a first detection signal through the first set of wires 506a. The detector system 208 may capacitively or inductively detect the first detection signal through the first set of wires 506a and/or the first smart glass unit 504a (e.g., after the first smart glass unit 504a is installed at the location and connected to the first set of wires 506a) and output an indication that the first detection signal has been received. An operator holding the detector system 208 at the location may determine that the port of the first controller 502a is wired to the first smart glass unit 504a positioned at the location where the detector system 208 detected the detection signal. The operator holding the detector system 208 may then map the port of the first controller 502a to the first smart glass unit 504a at the location where the detector system 208 detected the first detection signal. For example, the operator holding the detector system 208 may record that the port of the first controller 502a is mapped to the first smart glass unit 504a at the location where the detector system 208 detected the first detection signal and store that mapping in a data store for use (e.g., tint control) by the system controller 501 (e.g., a building automation system (BAS)). In some aspects, as described herein, the detector system 208 may automatically and/or wirelessly transmit the mapping to the data store and/or the system controller 501 for storage and subsequent operation (e.g., tint control) of the first smart glass unit 504a.

As another example, another port of the first controller 502a may not be assigned to a particular location for the second smart glass unit 504b. The second set of wires 506b may be electrically connected from the other port of the first controller 502a and may be positioned to extend to an unassigned location for installing the second smart glass unit 504b. Once the second set of wires 506b are connected to the other port of the first controller 502a and extended to the location (e.g., before or after the second smart glass unit 504b is installed at the location), the first controller 502a may transmit a second detection signal through the second set of wires 506b. The detector system 208 may capacitively or inductively detect the second detection signal through the second set of wires 506b and/or the second smart glass unit 504b (e.g., after the second smart glass unit 504b is installed at the location and connected to the second set of wires 506b) and output an indication that the second detection signal has been received. An operator holding the detector system 208 at the location may determine that the other port of the first controller 502a is wired to the second smart glass unit 504b positioned at the location where the detector system 208 detected the detection signal. The operator holding the detector system 208 may then map the other port of the first controller 502a to the second smart glass unit 504b at the location where the detector system 208 detected the second detection signal. For example, the operator holding the detector system 208 may record that the other port of the first controller 502a is mapped to the second smart glass unit 504b at the location where the detector system 208 detected the second detection signal and store that mapping in a data store for use (e.g., tint control) by the system controller 501 (e.g., a building automation system (BAS)). In some aspects, as described herein, the detector system 208 may automatically and/or wirelessly transmit the mapping to the data store and/or the system controller 501 for storage and subsequent operation (e.g., tint control) of the second smart glass unit 504a.

As yet another example, the second controller 502b may not be assigned to a particular location for the third smart glass unit 504c. The third set of wires 506c may be electrically connected from the second controller 502b and may be positioned to extend to an unassigned location for installing the third smart glass unit 504c. Once the third set of wires 506c are connected to the second controller 502b and extended to the location (e.g., before or after the third smart glass unit 504c is installed at the location), the second controller 502b may transmit a third detection signal through the third set of wires 506c. The detector system 208 may capacitively or inductively detect the third detection signal through the third set of wires 506c and/or the third smart glass unit 504c (e.g., after the third smart glass unit 504c is installed at the location and connected to the third set of wires 506c) and output an indication that the third detection signal has been received. An operator holding the detector system 208 at the location may determine that the second controller 502b is wired to the third smart glass unit 504c positioned at the location where the detector system 208 detected the detection signal. The operator holding the detector system 208 may then map the second controller 502b to the third smart glass unit 504c at the location where the detector system 208 detected the third detection signal. For example, the operator holding the detector system 208 may record that the second controller 502b is mapped to the third smart glass unit 504c at the location where the detector system 208 detected the third detection signal and store that mapping in a data store for use (e.g., tint control) by the system controller 501 (e.g., a building automation system (BAS)). In some aspects, as described herein, the detector system 208 may automatically and/or wirelessly transmit the mapping to the data store and/or the system controller 501 for storage and subsequent operation (e.g., tint control) of the third smart glass unit 504c.

FIG. 6 illustrates a block diagram of an example method 600 according to some aspects of this disclosure. The method 600 may include and/or may be implemented using one or more same or similar features as the features described with respect to or illustrated in FIGS. 1, 2, 3, 4, 5, and 10. For example, the method 600 may be implemented in the EC system 100 of FIG. 1, the system 200 of FIG. 2, the detector system 208 of FIG. 3, the system 400 of FIG. 4, the system 500 of FIG. 5, and/or the computer system 1000 of FIG. 10. In addition, one or more steps described herein with respect to the method 600 of FIG. 6 may be used or implemented with any one or more steps of the method 700 of FIG. 7, the method 800 of FIG. 8, and/or the method 900 of FIG. 9. FIG. 6, as with the other included figures, is shown for illustrative purposes and does not limit either the possible embodiments of the present invention or the claims.

At step 601, a controller transmits, through one or more wires associated with a smart glass unit, a tint signal for the smart glass unit to control a tint level of the smart glass unit. For example, the controller may generate and transmit tint control signals, via the wire(s), to the smart glass unit to increase, decrease, or maintain a tint level of the smart glass unit. At step 603, the controller transmits, through the same one or more wires associated with the smart glass unit, a detection signal for determining a location of the smart glass unit, the detection signal does not control the tint level of the smart glass unit. For example, the controller may generate and transmit a smart glass unit detection signal, via the wire(s) and independent of any other type of signal including a tint control signal, for detection of the smart glass unit. The smart glass unit detection signal may be a signal that does not control a tint level of the smart glass unit and/or any other smart glass unit. It should be understood that the controller may transmit both the tint control signal(s) and the smart glass unit detection signals over the same wire(s) at the same time or at different times. In some aspects, the controller may transmit only the detection signal without transmitting a tint control signal.

At step 605, a detector system detects the detection signal at or near the smart glass unit, and at step 607, the detector system produces at least one of a light indication, a vibration indication, or a sound indication based on the detection signal for determining the location of the smart glass unit. For example, the detector system may be held by an operator (e.g., a person) and may be positioned against or near the smart glass unit and/or against or near the wire(s) to detect the detection signal from the controller. For instance, the detector system may capacitively detect, via electric field coupling, and/or inductively detect, via magnetic field coupling, the detection signal over the wire(s) associated with the smart glass unit and/or adjacent (e.g., against) a pane of the smart glass unit for identifying the smart glass unit. In some aspects, upon detecting the detection signal, the detector system may generate one or more tones through a speaker of the detection system. The one or more tones may include a specific pitch assigned to the smart glass unit. Additionally, or alternatively, the one or more tones may include a series of different pitches assigned to the smart glass unit. Additionally, or alternatively, the one or more tones may include a sequence of pulses assigned to the smart glass unit. Thus, upon detecting the detection signal, the detector system may, through the speaker, project a tone or sound having a specific pitch (e.g., unique to the smart glass unit), having a particular series of pitches (e.g., one or more different pitches and/or one or more same pitches) (e.g., unique to the smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, the detecting signal may include a frequency (e.g., a sine wave, a square wave) that is unique to the smart glass unit for identifying the smart glass unit. Additionally, or alternatively, upon detecting the detection signal, the detector system may, through the light, emit a light signal having a specific brightness or color (e.g., unique to the smart glass unit), having a particular series of flashes (e.g., one or more different flashes and/or one or more same flashes) (e.g., unique to the smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). Additionally, or alternatively, upon detecting the detection signal, the detector system may, through a haptic device within the detector system, vibrate according a specific frequency (e.g., unique to the smart glass unit), according to a particular series of vibrations (e.g., unique to the smart glass unit), and/or according to a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, a controller may transmit a detection signal(s) such that multiple frequencies are simultaneously received by a single smart glass unit. For example, a controller may transmit a detection signal(s) that include a dual-tone multi-frequency (DTMF) signal.

FIG. 7 illustrates a block diagram of an example method 700 according to some aspects of this disclosure. The method 700 may include and/or may be implemented using one or more same or similar features as the features described with respect to or illustrated in FIGS. 1, 2, 3, 4, 5, and 10. For example, the method 700 may be implemented in the EC system 100 of FIG. 1, the system 200 of FIG. 2, the detector system 208 of FIG. 3, the system 400 of FIG. 4, the system 500 of FIG. 5, and/or the computer system 1000 of FIG. 10. In addition, one or more steps described herein with respect to the method 700 of FIG. 7 may be used or implemented with any one or more steps of the method 600 of FIG. 6, the method 800 of FIG. 8, and/or the method 900 of FIG. 9. FIG. 7, as with the other included figures, is shown for illustrative purposes and does not limit either the possible embodiments of the present invention or the claims.

At step 701, a controller transmits, using one or more wires, a tint signal to a smart glass unit. For example, the controller may generate and transmit tint control signals, via the wire(s), to the smart glass unit to increase, decrease, or maintain a tint level of the smart glass unit. At step 703, the controller transmits, using the same one or more wires, a detection signal, independent of the tint signal to the smart glass unit for determining a location of the smart glass unit via at least one of electric field coupling or magnetic field coupling. For example, the controller may generate and transmit a smart glass unit detection signal, via the wire(s) and independent of any other type of signal including a tint control signal, for detection of the smart glass unit. The smart glass unit detection signal may be a signal that does not control a tint level of the smart glass unit and/or any other smart glass unit. It should be understood that the controller may transmit both the tint control signal(s) and the smart glass unit detection signals over the same wire(s) at the same time or at different times. In some aspects, the controller may transmit only the detection signal without transmitting a tint control signal.

At step 705, a detector capacitively detects, via the electric field coupling, or inductively detects, via the magnetic field coupling, the detection signal at or near the smart glass unit, and at step 707, the detector produces at least one of a light indication, a vibration indication, or a sound indication based on the detection signal for determining the location of the smart glass unit. For example, the detector system may be held by an operator (e.g., a person) and may be positioned against or near the smart glass unit and/or against or near the wire(s) to detect the detection signal from the controller. For instance, the detector system may capacitively detect, via electric field coupling, and/or inductively detect, via magnetic field coupling, the detection signal over the wire(s) associated with the smart glass unit and/or adjacent (e.g., against) a pane of the smart glass unit for identifying the smart glass unit. In some aspects, upon detecting the detection signal, the detector system may generate one or more tones through a speaker of the detection system. The one or more tones may include a specific pitch assigned to the smart glass unit. Additionally, or alternatively, the one or more tones may include a series of different pitches assigned to the smart glass unit. Additionally, or alternatively, the one or more tones may include a sequence of pulses assigned to the smart glass unit. Thus, upon detecting the detection signal, the detector system may, through the speaker, project a tone or sound having a specific pitch (e.g., unique to the smart glass unit), having a particular series of pitches (e.g., one or more different pitches and/or one or more same pitches) (e.g., unique to the smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, the detecting signal may include a frequency (e.g., a sine wave, a square wave) that is unique to the smart glass unit for identifying the smart glass unit. Additionally, or alternatively, upon detecting the detection signal, the detector system may, through the light, emit a light signal having a specific brightness or color (e.g., unique to the smart glass unit), having a particular series of flashes (e.g., one or more different flashes and/or one or more same flashes) (e.g., unique to the smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). Additionally, or alternatively, upon detecting the detection signal, the detector system may, through a haptic device within the detector system, vibrate according a specific frequency (e.g., unique to the smart glass unit), according to a particular series of vibrations (e.g., unique to the smart glass unit), and/or according to a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, a controller may transmit a detection signal(s) such that multiple frequencies are simultaneously received by a single smart glass unit. For example, a controller may transmit a detection signal(s) that include a dual-tone multi-frequency (DTMF) signal.

FIG. 8 illustrates a block diagram of an example method 800 according to some aspects of this disclosure. The method 800 may include and/or may be implemented using one or more same or similar features as the features described with respect to or illustrated in FIGS. 1, 2, 3, 4, 5, and 10. For example, the method 800 may be implemented in the EC system 100 of FIG. 1, the system 200 of FIG. 2, the detector system 208 of FIG. 3, the system 400 of FIG. 4, the system 500 of FIG. 5, and/or the computer system 1000 of FIG. 10. In addition, one or more steps described herein with respect to the method 800 of FIG. 8 may be used or implemented with any one or more steps of the method 600 of FIG. 6, the method 700 of FIG. 7, and/or the method 900 of FIG. 9. FIG. 8, as with the other included figures, is shown for illustrative purposes and does not limit either the possible embodiments of the present invention or the claims.

At step 801, a controller transmits, using a first set of one or more wires, a tint signal to a first smart glass unit. For example, the controller may generate and transmit tint control signals, via a first set of wire(s), to the first smart glass unit to increase, decrease, or maintain a tint level of the first smart glass unit. At step 803, the controller transmits, using the same first set of one or more wires, a detection signal, independent of the tint signal to the first smart glass unit for determining a location of the first smart glass unit via at least one of electric field coupling or magnetic field coupling. For example, the controller may generate and transmit a smart glass unit detection signal, via the first set of wire(s) and independent of any other type of signal including a tint control signal, for detection of the first smart glass unit. The smart glass unit detection signal may be a signal that does not control a tint level of the first smart glass unit and/or any other smart glass unit. It should be understood that the controller may transmit both the tint control signal(s) and the smart glass unit detection signals over the same first set of wire(s) at the same time or at different times. It should be understood that at least with respect to steps 801 and 803, step 801 may be performed before, during, or after step 803. In some aspects, the controller may transmit only the detection signal without transmitting a tint control signal.

At step 805, a detector capacitively detects, via the electric field coupling, or inductively detects, via the magnetic field coupling, the detection signal at or near the first smart glass unit, and at step 807, the detector produces at least one of a light indication, a vibration indication, or a sound indication based on the detection signal for determining the location of the first smart glass unit. For example, the detector system may be held by an operator (e.g., a person) and may be positioned against or near the first smart glass unit and/or against or near the first set of wire(s) to detect the detection signal from the controller. For instance, the detector system may capacitively detect, via electric field coupling, and/or inductively detect, via magnetic field coupling, the detection signal over the wire(s) associated with the first smart glass unit and/or adjacent (e.g., against) a pane of the first smart glass unit for identifying the first smart glass unit. In some aspects, upon detecting the detection signal, the detector system may generate one or more tones through a speaker of the detection system. The one or more tones may include a specific pitch assigned to the first smart glass unit. Additionally, or alternatively, the one or more tones may include a series of different pitches assigned to the first smart glass unit. Additionally, or alternatively, the one or more tones may include a sequence of pulses assigned to the first smart glass unit. Thus, upon detecting the detection signal, the detector system may, through the speaker, project a tone or sound having a specific pitch (e.g., unique to the first smart glass unit), having a particular series of pitches (e.g., one or more different pitches and/or one or more same pitches) (e.g., unique to the first smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, the detecting signal may include a frequency (e.g., a sine wave, a square wave) that is unique to the first smart glass unit for identifying the first smart glass unit. Additionally, or alternatively, upon detecting the detection signal, the detector system may, through the light, emit a light signal having a specific brightness or color (e.g., unique to the first smart glass unit), having a particular series of flashes (e.g., one or more different flashes and/or one or more same flashes) (e.g., unique to the first smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). Additionally, or alternatively, upon detecting the detection signal, the detector system may, through a haptic device within the detector system, vibrate according a specific frequency (e.g., unique to the first smart glass unit), according to a particular series of vibrations (e.g., unique to the first smart glass unit), and/or according to a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time).

At step 809, the controller transmits, using a second set of one or more wires, a tint signal to a second smart glass unit. For example, the controller may generate and transmit tint control signals, via a second set of wire(s), to the second smart glass unit to increase, decrease, or maintain a tint level of the second smart glass unit. At step 811, the controller transmits, using the same second set of one or more wires, a detection signal, independent of the tint signal to the second smart glass unit for determining a location of the second smart glass unit via at least one of electric field coupling or magnetic field coupling. For example, the controller may generate and transmit a smart glass unit detection signal, via the second set of wire(s) and independent of any other type of signal including a tint control signal, for detection of the second smart glass unit. The smart glass unit detection signal may be a signal that does not control a tint level of the second smart glass unit and/or any other smart glass unit. It should be understood that the controller may transmit both the tint control signal(s) and the smart glass unit detection signals over the same first set of wire(s) at the same time or at different times. It should be understood that at least with respect to steps 809 and 811, step 809 may be performed before, during, or after step 811.

At step 813, the detector capacitively detects, via the electric field coupling, or inductively detects, via the magnetic field coupling, the detection signal at or near the second smart glass unit, and at step 815, the detector produces at least one of a light indication, a vibration indication, or a sound indication based on the detection signal for determining the location of the second smart glass unit. For example, the detector system may be held by an operator (e.g., a person) and may be positioned against or near the second smart glass unit and/or against or near the second set of wire(s) to detect the detection signal from the controller. For instance, the detector system may capacitively detect, via electric field coupling, and/or inductively detect, via magnetic field coupling, the detection signal over the wire(s) associated with the second smart glass unit and/or adjacent (e.g., against) a pane of the second smart glass unit for identifying the second smart glass unit. In some aspects, upon detecting the detection signal, the detector system may generate one or more tones through a speaker of the detection system. The one or more tones may include a specific pitch assigned to the second smart glass unit. Additionally, or alternatively, the one or more tones may include a series of different pitches assigned to the second smart glass unit. Additionally, or alternatively, the one or more tones may include a sequence of pulses assigned to the second smart glass unit. Thus, upon detecting the detection signal, the detector system may, through the speaker, project a tone or sound having a specific pitch (e.g., unique to the second smart glass unit), having a particular series of pitches (e.g., one or more different pitches and/or one or more same pitches) (e.g., unique to the second smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). In some aspects, the detecting signal may include a frequency (e.g., a sine wave, a square wave) that is unique to the second smart glass unit for identifying the second smart glass unit. Additionally, or alternatively, upon detecting the detection signal, the detector system may, through the light, emit a light signal having a specific brightness or color (e.g., unique to the second smart glass unit), having a particular series of flashes (e.g., one or more different flashes and/or one or more same flashes) (e.g., unique to the second smart glass unit), and/or having a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time). Additionally, or alternatively, upon detecting the detection signal, the detector system may, through a haptic device within the detector system, vibrate according a specific frequency (e.g., unique to the second smart glass unit), according to a particular series of vibrations (e.g., unique to the second smart glass unit), and/or according to a sequence of pulses (e.g., that individually last for one or more same amounts of time and/or one or more different amounts of time, that are spaced by breaks that last for one or more same amounts of time and/or one or more different amounts of time, that in total have a duration that lasts for a unique amount of time).

FIG. 9 illustrates a block diagram of an example method 900 according to some aspects of this disclosure. The method 900 may include and/or may be implemented using one or more same or similar features as the features described with respect to or illustrated in FIGS. 1, 2, 3, 4, 5, and 10. For example, the method 900 may be implemented in the EC system 100 of FIG. 1, the system 200 of FIG. 2, the detector system 208 of FIG. 3, the system 400 of FIG. 4, the system 500 of FIG. 5, and/or the computer system 1000 of FIG. 10. In addition, one or more steps described herein with respect to the method 900 of FIG. 9 may be used or implemented with any one or more steps of the method 600 of FIG. 6, the method 700 of FIG. 7, and/or the method 800 of FIG. 8. FIG. 9, as with the other included figures, is shown for illustrative purposes and does not limit either the possible embodiments of the present invention or the claims.

At step 901, a system controller transmits a command to a first controller to send a tint signal to a first smart glass unit to control a tint level of the first smart glass unit, and at step 903, the system controller transmits a command to a second controller to send a tint signal to a second smart glass unit to control a tint level of the second smart glass unit. For example, the system controller may be configured to transmit a command signal to the first controller instructing the first controller to transmit a tint control signal, as described herein, to the first smart glass unit and the system controller may be configured to transmit a command signal to the second controller instructing the second controller to transmit a tint control signal, as described herein, to the second smart glass unit.

At step 905, the system controller transmits a command signal to the first controller to send a detection signal, independent of any tint signal, to the first smart glass unit for determining a location of the first smart glass unit, and at step 907, the system controller transmits a command signal to the second controller to send a detection signal, independent of any tint signal, to the second smart glass unit for determining a location of the second smart glass unit. For example, before, during, and/or after the system controller transmits a command signal to the first controller instructing the first controller to transmit a tint control signal to the first smart glass unit and/or before, during, and/or after the system controller transmits a command signal to the second controller instructing the second controller to transmit a tint control signal to the second smart glass unit, the system controller may also be configured to transmit another command signal to the first controller instructing the first controller to transmit a smart glass unit detection signal, as described herein, to the first smart glass unit and/or the system controller may also be configured to transmit another command signal to the second controller instructing the second controller to transmit a smart glass unit detection signal, as described herein, to the second smart glass unit. In some aspects, the system controller may transmit only a command signal to a controller to transmit the detection signal without transmitting a command signal to the controller to transmit a tint control signal.

At step 909, the system controller receives a first signal mapping the detection signal sent to the first smart glass unit with the location of the first smart glass unit and stores the mapping of the detection signal sent to the first smart glass unit and the location of the first smart glass unit in a data store. For example, the system controller may receive data mapping the first controller to the first smart glass unit, and/or mapping the first controller to the particular location including the first smart glass unit. For instance, upon the detector system detecting a detection signal at or near a location associated with the first smart glass unit, an operator (e.g., a person) of the detector system and/or the detector system itself (e.g., via wireless transmission) may transmit data to the system controller mapping the particular location of the first smart glass unit receiving the detection signal with the first controller. The system controller may receive the data and store the data in a data store (e.g., system memory 1020 of FIG. 10, data 1026 of FIG. 10) for subsequent tint control of the first smart glass unit located at the particular position. For example, using the data mapping the first controller to the first smart glass unit, and/or mapping the first controller to a particular location including first smart glass unit, the system controller may transmit command signals to the first controllers to maintain and/or change tint levels of the first smart glass unit.

At step 911, the system controller receives a second signal mapping the detection signal sent to the second smart glass unit with the location of the second smart glass unit and stores the mapping of the detection signal sent to the second smart glass unit and the location of the second smart glass unit in a data store. For example, the system controller may receive data mapping the second controller to the second smart glass unit, and/or mapping the second controller to the particular location including the second smart glass unit. For instance, upon the detector system detecting a detection signal at or near a location associated with the second smart glass unit, an operator (e.g., a person) of the detector system and/or the detector system itself (e.g., via wireless transmission) may transmit data to the system controller mapping the particular location of the second smart glass unit receiving the detection signal with the second controller. The system controller may receive the data and store the data in a data store (e.g., system memory 1020 of FIG. 10, data 1026 of FIG. 10) for subsequent tint control of the second smart glass unit located at the particular position. For example, using the data mapping the second controller to the second smart glass unit, and/or mapping the second controller to a particular location including second smart glass unit, the system controller may transmit command signals to the second controllers to maintain and/or change tint levels of the second smart glass unit.

In some aspects, a system is provided. The system includes a smart glass unit. The system also includes a controller. The controller is configured to send, using one or more wires, a tint signal to the smart glass unit to control a tint level of the smart glass unit. The controller is also configured to send, using the same one or more wires, a detection signal, independent of the tint signal, to the smart glass unit for determining a location of the smart glass unit via at least one of an electric field coupling or a magnetic field coupling. In some aspects, the controller is configured to send the detection signal to the smart glass unit for determining the location of the smart glass unit without controlling the tint level of the smart glass unit. In some aspects, the smart glass unit includes a first smart glass unit, the system further includes a second smart glass unit, and the controller is further configured to send the detection signal to the second smart glass unit for determining a location of the second smart glass unit. In some aspects, the smart glass unit includes a first smart glass unit, the detection signal includes a first detection signal, the system further includes a second smart glass unit, and the controller is further configured to send a second detection signal, different from the first detection signal, to the second smart glass unit, independent of the first detection signal, for identifying the location of the second smart glass unit via at least one of the electric field coupling or the magnetic field coupling. In some aspects, the smart glass unit includes a first smart glass unit, the system further includes a second smart glass unit, and the controller is further configured to after sending the detection signal to the first smart glass unit for determining the location of the first smart glass unit, send the detection signal to the second smart glass unit for determining the location of the second smart glass unit. In some aspects, the detection signal is configured to generate one or more tones including at least one of a specific pitch assigned to the smart glass unit, a series of pitches assigned to the smart glass unit, or a sequence of pulses assigned to the smart glass unit. In some aspects, the detection signal includes a frequency assigned to the smart glass unit. In some aspects, the system further includes a detector. The detector is configured to capacitively detect, via the electric field coupling, or inductively detect, via the magnetic field coupling, the detection signal at the smart glass unit, and produce at least one of a light indication, a vibration, or a sound based on the detection signal for determining the location of the smart glass unit. In some aspects, the detector is further configured to transmit the location of the smart glass unit to the controller for associating the detection signal with the location of the smart glass unit. In some aspects, the location of the smart glass unit is based on a location of the detector, determined by the detector when the detector detects the detection signal at the smart glass unit. In some aspects, the controller shares a physical location with the smart glass unit. In some aspects, the controller is positioned at a different location than the smart glass unit.

In some aspects, a system is provided. The system includes a controller. The controller is configured to transmit, through one or more wires associated with a smart glass unit, a tint signal for the smart glass unit to control a tint level of the smart glass unit. The controller is also configured to transmit a detection signal, through the same one or more wires associated with the smart glass unit, for determining a location of the smart glass unit, the detection signal does not control the tint level of the smart glass unit. In some aspects, the controller is configured to transmit the detection signal through one or more other wires for determining a location of another smart glass unit. In some aspects, the detection signal includes a first detection signal, and the controller is further configured to transmit a second detection signal, different from the first detection signal, through one or more other wires associated with another smart glass unit for determining a location of the other smart glass unit, where the second detection signal is different from the first detection signal. In some aspects, the controller is configured to after transmitting the detection signal through the one or more wires associated with the smart glass unit for determining the location of the smart glass unit, transmit the detection signal through one or more other wires associated with another smart glass unit for determining a location of the other smart glass unit.

In some aspects, a system is provided. The system includes a supervisory controller. The system also includes a data storage for storing mappings of detection signals with respective locations of smart glass units. The system further includes a plurality of controllers in electronic communication with the supervisory controller, where the plurality of controllers comprises at least a first controller and a second controller. In addition, the system includes a first smart glass unit electrically wired to the first controller. The system includes a second smart glass unit electrically wired to the second controller. The supervisory controller is configured to send a first command to the first controller and the second controller to send a tint signal to the first smart glass unit and the second smart glass unit, respectively, to control a tint level of the first smart glass unit and the second smart glass unit, respectively. The supervisory controller is also configured to send a second command to the first controller and the second controller to send respective detection signals, independent of the tint signal, to the first smart glass unit and the second smart glass unit for determining respective locations of the first smart glass unit and the second smart glass unit. The supervisory controller is further configured to receive a first signal mapping the detection signal sent to the first smart glass unit with the location of the first smart glass unit and store the mapping of the detection signal sent to the first smart glass unit and the location of the first smart glass unit in the data storage. In addition, the supervisory controller is configured to receive a second signal mapping the detection signal sent to the second smart glass unit with the location of the second smart glass unit and store the mapping of the detection signal sent to the second smart glass unit and the location of the second smart glass unit in the data storage. In some aspects, the supervisory controller is configured to send the second command to the first controller so that the first controller sends the detection signal to the first smart glass unit for identifying the first smart glass unit without sending the tint signal to control the tint level of the first smart glass unit, and where the supervisory controller is configured to send the second command to the second controller so that the second controller sends the detection signal to the second smart glass unit for identifying the second smart glass unit without sending the tint signal to control the tint level of the second smart glass unit. In some aspects, the controller shares a location with the first smart glass unit and the second controller shares a location with the second smart glass unit. In some aspects, the first controller is positioned at a different location than the first smart glass unit, and wherein the second controller is positioned at a different location than the second smart glass unit.

In some aspects, a signal detector system for a smart glass unit system is provided. The signal detector system includes a detector configured to detect a detection signal via at least one of an electric field coupling or a magnetic field coupling. The signal detector system also includes a controller configured to determine a location of the smart glass unit at the time the detection signal is detected via at least one of the electric field coupling or the magnetic field coupling. The signal detector system further includes a transmitter configured to transmit a signal to a system controller that includes the location of the smart glass unit at the time the detection signal is detected via at least one of the electric field coupling or the magnetic field coupling. In some aspects, the controller is further configured to determine a location of the detector at the time the detector detects the detection signal via at least one of the electric field coupling or the magnetic field coupling, and wherein the location of the smart glass unit at the time the detection signal is detected via at least one of the electric field coupling or the magnetic field coupling is based on the location of the signal detector. In some aspects, the detection signal is configured to generate one or more tones including at least one of a specific pitch assigned to the smart glass unit, a series of pitches assigned to the smart glass unit, or a sequence of pulses assigned to the smart glass unit. In some aspects, the detection signal includes a frequency assigned to the smart glass unit.

FIG. 10 illustrates an example computer system 1000 that may be used in some embodiments. The methods, features, mechanisms, techniques and/or functionality described herein may in various embodiments be implemented by any combination of hardware and software. For example, in one embodiment, the methods may be implemented by a computer system (e.g., a computer system as in FIG. 10) that includes one or more processors executing program instructions stored on a computer-readable storage medium coupled to the processors. The program instructions may implement the methods, features, mechanisms, techniques and/or functionality described herein. The various methods as illustrated in the figures and described herein represent example embodiments of methods. The order of any method may be changed, and various elements may be added, reordered, combined, omitted, modified, etc.

FIG. 10 is a block diagram illustrating a computer system 1000 according to some aspects, as well as various other systems, components, services or devices described herein. The computer system 1000, for example, may be included in the controller and/or system controllers described herein with respect to FIGS. 1, 2, 3, 4, and 5 as well as a combination one or more steps from any of the methods described herein. For example, computer system 1000 may implement a control unit configured to implement and/or utilize the features, methods, mechanisms and/or techniques described herein, in different embodiments. Computer system 1000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 1000 includes one or more processors 1010 (any of which may include multiple cores, which may be single or multi-threaded) coupled to a system memory 1020 via an input/output (I/O) interface 1030. Computer system 1000 further includes a network interface 1040 coupled to I/O interface 1030. In various embodiments, computer system 1000 may be a uniprocessor system including one processor 1010, or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA. The computer system 1000 also includes one or more network communication devices (e.g., network interface 1040) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote-control device (e.g., a remote control), a wall mounted (e.g., hard wired) device, or an application executing on any of various types of devices (e.g., a portable phone, smart phone, tablet and/or desktop computer are just a few examples).

In the illustrated embodiment, computer system 1000 is coupled to one or more portable storage devices 1080 via device interface 1070. In various embodiments, portable storage devices 1080 may correspond to disk drives, tape drives, solid state memory, other storage devices, or any other persistent storage device. Computer system 1000 (or a distributed application or operating system operating thereon) may store instructions and/or data in portable storage devices 1080, as desired, and may retrieve the stored instruction and/or data as needed. In some embodiments, portable device(s) 1080 may store information regarding one or EC devices, such as information regarding design parameters, etc. usable by a controller when changing tint levels using the techniques described herein.

Computer system 1000 includes one or more system memories 1020 that can store instructions and data accessible by processor(s) 1010. In various embodiments, system memories 1020 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 1020 may contain program instructions 1025 that are executable by processor(s) 1010 to implement the methods and techniques described herein. In various embodiments, program instructions 1025 may be encoded in platform native binary, any interpreted language such as Java™ bytecode, or in any other language such as C/C++, Java™, etc., or in any combination thereof. For example, in the illustrated embodiment, program instructions 1025 include program instructions executable to implement the functionality of a control unit, a stack voltage measurement module, an equivalent series resistance (ESR) module, an open circuit voltage (OCV) module, a supervisory control system, local controller, project database, etc., in different embodiments. In some embodiments, program instructions 1025 may implement a control unit configured to implement and/or utilize the features, methods, mechanisms and/or techniques described herein, and/or other components.

In some embodiments, program instructions 1025 may include instructions executable to implement an operating system (not shown), which may be any of various operating systems, such as UNIX, LINUX, Solaris™, MacOS™, Windows™, etc. Any or all of program instructions 1025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 1000 via I/O interface 1030. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 1000 as system memory 1020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 1040.

In one embodiment, I/O interface 1030 may coordinate I/O traffic between processor 1010, system memory 1020 and any peripheral devices in the system, including through network interface 1040 or other peripheral interfaces, such as device interface 1070. In some aspects, the network interface 1040 and/or the device interface 1070 may include a transceiver to wirelessly communicate with the other devices 1060 and/or the portable devices 1080. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments, some or all of the functionality of I/O interface 1030, such as an interface to system memory 1020, may be incorporated directly into processor 1010.

Network interface 1040 may allow data to be exchanged between computer system 1000 and other devices attached to a network, such as other computer systems 1060. In addition, network interface 1040 may allow communication between computer system 1000 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 1000. Multiple input/output devices may be present in computer system 1000 or may be distributed on various nodes of a distributed system that includes computer system 1000. In some embodiments, similar input/output devices may be separate from computer system 1000 and may interact with one or more nodes of a distributed system that includes computer system 1000 through a wired or wireless connection, such as over network interface 1040. Network interface 1040 may commonly support one or more wireless networking protocols (e.g., Wi-Fi/IEEE 802.11, or another wireless networking standard). However, in various embodiments, network interface 1040 may support communication via any suitable wired or wireless general data networks, such as other types of Ethernet networks, for example. Additionally, network interface 1040 may support communication via telecommunications/telephony networks such as analog voice networks or digital fiber communications networks, via storage area networks such as Fibre Channel SANs, or via any other suitable type of network and/or protocol. In various embodiments, computer system 1000 may include more, fewer, or different components than those illustrated in FIG. 10 (e.g., displays, video cards, audio cards, peripheral devices, other network interfaces such as an ATM interface, an Ethernet interface, a Frame Relay interface, etc.)

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system comprising:
a smart glass unit; and
a controller configured to:
send, using one or more wires, a tint signal to the smart glass unit to control a tint level of the smart glass unit, and
send, using the same one or more wires, a detection signal, independent of the tint signal, to the smart glass unit for determining a location of the smart glass unit via at least one of an electric field coupling or a magnetic field coupling.

2. The system of claim 1, wherein the controller is configured to send the detection signal to the smart glass unit for determining the location of the smart glass unit without controlling the tint level of the smart glass unit.

3. The system of claim 1, wherein the smart glass unit comprises a first smart glass unit, wherein the system further comprises a second smart glass unit, and wherein the controller is further configured to:
send the detection signal to the second smart glass unit for determining a location of the second smart glass unit.

4. The system of claim 1, wherein the smart glass unit comprises a first smart glass unit, wherein the detection signal comprises a first detection signal, wherein the system further comprises a second smart glass unit, and wherein the controller is further configured to:
send a second detection signal, different from the first detection signal, to the second smart glass unit, independent of the first detection signal, for identifying the location of the second smart glass unit via at least one of the electric field coupling or the magnetic field coupling.

5. The system of claim 1, wherein the smart glass unit comprises a first smart glass unit, wherein the system further comprises a second smart glass unit, and wherein the controller is further configured to:
after sending the detection signal to the first smart glass unit for determining the location of the first smart glass unit, send the detection signal to the second smart glass unit for determining the location of the second smart glass unit.

6. The system of claim 1, wherein the detection signal is configured to generate one or more tones including at least one of a specific pitch assigned to the smart glass unit, a series of pitches assigned to the smart glass unit, or a sequence of pulses assigned to the smart glass unit.

7. The system of claim 1, wherein the detection signal includes a frequency assigned to the smart glass unit.

8. The system of claim 1, further comprising a detector, wherein the detector is configured to:
capacitively detect, via the electric field coupling, or inductively detect, via the magnetic field coupling, the detection signal at the smart glass unit; and
produce at least one of a light indication, a vibration, or a sound based on the detection signal for determining the location of the smart glass unit.

9. The system of claim 8, wherein the detector is further configured to:
transmit the location of the smart glass unit to the controller for associating the detection signal with the location of the smart glass unit.

10. The system of claim 9, wherein the location of the smart glass unit is based on a location of the detector, determined by the detector when the detector detects the detection signal at the smart glass unit.

11. The system of claim 1, wherein the controller shares a physical location with the smart glass unit.

12. The system of claim 1, wherein the controller is positioned at a different location than the smart glass unit.

13. A system comprising:
a controller configured to:
transmit, through one or more wires associated with a smart glass unit, a tint signal for the smart glass unit to control a tint level of the smart glass unit,
transmit a detection signal, through the same one or more wires associated with the smart glass unit, for determining a location of the smart glass unit, wherein the detection signal does not control the tint level of the smart glass unit.

14. The system of claim 13, wherein controller is further configured to:
transmit the detection signal through one or more other wires for determining a location of another smart glass unit.

15. The system of claim 13, wherein the detection signal comprises a first detection signal, and wherein the controller is further configured to:
transmit a second detection signal, different from the first detection signal, through one or more other wires associated with another smart glass unit for determining a location of the other smart glass unit, wherein the second detection signal is different from the first detection signal.

16. The system of claim 13, wherein the controller is further configured to:
after transmitting the detection signal through the one or more wires associated with the smart glass unit for determining the location of the smart glass unit, transmit the detection signal through one or more other wires associated with another smart glass unit for determining a location of the other smart glass unit.

17. A system comprising:
a supervisory controller;
a data storage for mapping detection signals with respective locations of smart glass units;
a plurality of controllers in electronic communication with the supervisory controller, wherein the plurality of controllers comprises at least a first controller and a second controller;
a first smart glass unit electrically wired to the first controller; and
a second smart glass unit electrically wired to the second controller, wherein the supervisory controller is configured to:
send a first command to the first controller and the second controller to send a tint signal to the first smart glass unit and the second smart glass unit, respectively, to control a tint level of the first smart glass unit and the second smart glass unit, respectively,
send a second command to the first controller and the second controller to send respective detection signals, independent of the tint signal, to the first smart glass unit and the second smart glass unit for determining respective locations of the first smart glass unit and the second smart glass unit,
receive a first signal mapping the detection signal sent to the first smart glass unit with the location of the first smart glass unit and store the mapping of the detection signal sent to the first smart glass unit and the location of the first smart glass unit in the data storage, and
receive a second signal mapping the detection signal sent to the second smart glass unit with the location of the second smart glass unit and store the mapping of the detection signal sent to the second smart glass unit and the location of the second smart glass unit in the data storage.

18. The system of claim 17, wherein the supervisory controller is configured to send the second command to the first controller so that the first controller sends the detection signal to the first smart glass unit for identifying the first smart glass unit without sending the tint signal to control the tint level of the first smart glass unit, and wherein the supervisory controller is configured to send the second command to the second controller so that the second controller sends the detection signal to the second smart glass unit for identifying the first smart glass unit without sending the tint signal to control the tint level of the second smart glass unit.

19. The system of claim 17, wherein the first controller shares a location with the first smart glass unit and the second controller shares a location with the second smart glass unit.

20. The system of claim 17, wherein the first controller is positioned at a different location than the first smart glass unit, and wherein the second controller is positioned at a different location than the second smart glass unit.
